(19) United States
(12) Patent Application Publication
(10) Pub. No.: US 2009/0146083 A1
(43) Pub. Date: Jun. 11, 2009

(54) Hydrogen catalysis

(75) Inventor: Randell L. Mills, Cranbury, NJ (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Blacklight Power, Inc.

(21) Appl. No.: 12/213,476

(22) Filed: Jun. 19, 2008

Related U.S. Application Data
(63) Continuation of application No. 09/813,792, filed on Mar. 22, 2001, now abandoned.
(60) Provisional application No. 60/191,492, filed on Mar. 23, 2000.

(51) Int. Cl. G21G 4/00

(52) U.S. Cl. 250/493.1

(57) ABSTRACT

A catalytic reaction of atomic hydrogen is provided which produces a more stable or lower energy atomic hydrogen atom than uncatalyzed atomic hydrogen. The catalyzed lower energy hydrogen atom may serve as a reactant of a disproportionation reaction whereby it which accepts energy from an second catalyzed lower energy hydrogen atom to cause a further release of energy as the first atom undergoes a nonradiative electronic transition to a higher energy level while the second undergoes a transition to a lower energy level. The catalytic reaction and disproportionation reaction of lower energy atomic hydrogen may produce light, plasma, power, and novel hydrogen compounds. The light, plasma, power and compound source comprises a cell for the catalysis of atomic hydrogen and disproportionation reactions of lower energy atomic hydrogen to form novel hydrogen species and compositions of matter comprising hydrogen that is more stable or lower energy than uncatalyzed hydrogen. The compounds comprise at least one neutral, positive, or negative hydrogen species having a binding energy greater than its corresponding ordinary hydrogen species, or greater than any hydrogen species for which the corresponding ordinary hydrogen species is unstable or is not observed.

### CROSS REFERENCE TO RELATED APPLICATIONS

This application claims priority to U.S. Provisional Application No. U.S. 60/191,492 filed Mar. 23, 2000.

### I. INTRODUCTION

1. Field of the Invention

This invention is hydrogen reactions which may produce light, plasma, power, and novel hydrogen compounds. The light, plasma, power, and compound source comprises a cell for the catalysis of atomic hydrogen to form novel hydrogen species and compositions of matter comprising more stable hydrogen than uncatalyzed hydrogen. The catalyzed atomic hydrogen may react to cause electronic transitions involving a nonradiative energy transfer mechanism with a net release of energy and the formation of hydrogen containing compositions of matter of further increased stability.

2. Background of the Invention

### 2.1 Hydrogen Plasma

A historical motivation to cause EUV emission from a hydrogen gas was that the spectrum of hydrogen was first recorded from the only known source, the Sun. Developed sources that provide a suitable intensity are high voltage discharge, synchrotron, and inductively coupled plasma generators. An important variant of the later type of source is a tokomak that operates at temperatures in the tens of millions of degrees.

### 2.2 Hydride Ions

A hydride ion comprises two indistinguishable electrons bound to a proton. Alkali and alkaline earth hydrides react violently with water to release hydrogen gas which burns in air ignited by the heat of the reaction with water. Typically metal hydrides decompose upon heating at a temperature well below the melting point of the parent metal.

### II. SUMMARY OF THE INVENTION

An objective of the present invention is to generate a plasma and a source light such as visible and high energy light such as extreme ultraviolet light via the catalysis of atomic hydrogen.

Another objective is to react hydrogen with a catalyst to form more stable hydrogen than uncatalyzed hydrogen. The more stable lower energy hydrogen may serve as reactants to form lower energy hydrogen of further stability.

Another objective is to form novel hydride compounds comprising more stable hydrogen than uncatalyzed hydrogen.

### 1 Hydrinos

A hydrogen atom having a binding energy given by

$$Binding Energy = \frac{13.6 eV}{{( \frac{1}{p} )}^{2}} \qquad ( 1 )$$

where p is an integer greater than 1, preferably from 2 to 200, is disclosed in R. Mills, The Grand Unified Theory of Classical Quantum Mechanics, January 2000 Edition, BlackLight Power, Inc., Cranbury, N.J., Distributed by Amazon.com (“'00 Mills GUT”), provided by BlackLight Power, Inc., 493 Old Trenton Road, Cranbury, N.J., 08512; R. Mills, W. Good, A. Voigt, Jinquan Dong, “Minimum Heat of Formation of Potassium Iodo Hydride”, Int. J. Hydrogen Energy, submitted; R. Mills, “Spectroscopic Identification of a Novel Catalytic Reaction of Atomic Hydrogen and the Hydride Ion Product”, Int. J. Hydrogen Energy, submitted; R. Mills, N. Greenig, S. Hicks, “Optically Measured Power Balances of Anomalous Discharges of Mixtures of Argon, Hydrogen, and Potassium, Rubidium, Cesium, or Strontium Vapor”, Int. J. Hydrogen Energy, submitted; R. Mills, “The Grand Unified Theory of Classical Quantum Mechanics”, Global Foundation, Inc. Orbis Scientiae entitled The Role of Attractive and Repulsive Gravitational Forces in Cosmic Acceleration of Particles The Origin of the Cosmic Gamma Ray Bursts, (29th Conference on High Energy Physics and Cosmology Since 1964) Dr. Behram N. Kursunoglu, Chairman, Dec. 14-17, 2000, Lago Mar Resort, Fort Lauderdale, Fla., in press; R. Mills, “The Grand Unified Theory of Classical Quantum Mechanics”, Mod. Phys. Ltts. A, submitted; R. Mills and M. Nansteel, “Anomalous Argon-Hydrogen-Strontium Discharge”, IEEE Transactions on Plasma Science, submitted; R. Mills, B. Dhandapani, M. Nansteel, J. He, A. “Voigt, Identification of Compounds Containing Novel Hydride Ions by Nuclear Magnetic Resonance Spectroscopy”, Int. J. Hydrogen Energy, in press; R. Mills, “BlackLight Power Technology—A New Clean Energy Source with the Potential for Direct Conversion to Electricity”, Global Foundation International Conference on “Global Warming and Energy Policy”, Dr. Behram N. Kursunoglu, Chairman, Fort Lauderdale, Fla., Nov. 26-28, 2000, in press; R. Mills, The Nature of Free Electrons in Superfluid Helium—a Test of Quantum Mechanics and a Basis to Review its Foundations and Make a Comparison to Classical Theory, Int. J. Hydrogen Energy, in press; R. Mills, M. Nansteel, and Y. Lu, “Anomalous Hydrogen-Strontium Discharge”, European Journal of Physics D, submitted; R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943; R. Mills, “Observation of Extreme Ultraviolet Emission from Hydrogen-KI Plasmas Produced by a Hollow Cathode Discharge”, Int. J. Hydrogen Energy, in press; R. Mills, “Temporal Behavior of Light-Emission in the Visible Spectral Range from a T1-K2CO3-H-Cell”, Int. J. Hydrogen Energy, in press; R. Mills, T. Onuma, and Y. Lu, “Formation of a Hydrogen Plasma from an Incandescently Heated Hydrogen—Catalyst Gas Mixture with an Anomalous Afterglow Duration”, Int. J. Hydrogen Energy, in press; R. Mills, M. Nansteel, and Y. Lu, “Observation of Extreme Ultraviolet Hydrogen Emission from Incandescently Heated Hydrogen Gas with Strontium that Produced an Anomalous Optically Measured Power Balance”, Int. J. Hydrogen Energy, in press; R. Mills, B. Dhandapani, N. Greenig, J. He, “Synthesis and Characterization of Potassium Iodo Hydride”, Int. J. of Hydrogen Energy, Vol. 25, Issue 12, December, (2000), pp. 1185-1203; R. Mills, “Novel Inorganic Hydride”, Int. J. of Hydrogen Energy, Vol. 25, (2000), pp. 669-683; R. Mills, B. Dhandapani, M. Nansteel, J. He, T. Shannon, A. Echezuria, “Synthesis and Characterization of Novel Hydride Compounds”, Int. J. of Hydrogen Energy, in press; R. Mills, “Highly Stable Novel Inorganic Hydrides”, Journal of Materials Research, submitted; R. Mills, “Novel Hydrogen Compounds from a Potassium Carbonate Electrolytic Cell”, Fusion Technology, Vol. 37, No. 2, March, (2000), pp. 157-182; R. Mills, “The Hydrogen Atom Revisited”, Int. J. of Hydrogen Energy, Vol. 25, Issue 12, December, (2000), pp. 1171-1183; Mills, R., Good, W., “Fractional Quantum Energy Levels of Hydrogen”, Fusion Technology, Vol. 28, No. 4, November, (1995), pp. 1697-1719; Mills, R., Good, W., Shaubach, R., “Dihydrino Molecule Identification”, Fusion Technology, Vol. 25, 103 (1994); R. Mills and S. Kneizys, Fusion Technol. Vol. 20, 65 (1991); and in prior PCT applications PCT/US00/20820; PCT/US00/20819; PCT/US99/17171; PCT/US99/17129; PCT/US 98/22822; PCT/US98/14029; PCT/US96/07949; PCT/US94/02219; PCT/US91/8496; PCT/US90/1998; and prior U.S. patent application Ser. No. 09/225,687, filed on Jan. 6, 1999; Ser. No. 60/095,149, filed Aug. 3, 1998; Ser. No. 60/101,651, filed Sep. 24, 1998; Ser. No. 60/105,752, filed Oct. 26, 1998; Ser. No. 60/113,713, filed Dec. 24, 1998; Ser. No. 60/123,835, filed Mar. 11, 1999; Ser. No. 60/130,491, filed Apr. 22, 1999; Ser. No. 60/141,036, filed Jun. 29, 1999; Ser. No. 09/009,294 filed Jan. 20, 1998; Ser. No. 09/111,160 filed Jul. 7, 1998; Ser. No. 09/111,170 filed Jul. 7, 1998; Ser. No. 09/111,016 filed Jul. 7, 1998; Ser. No. 09/111,003 filed Jul. 7, 1998; Ser. No. 09/110,694 filed Jul. 7, 1998; Ser. No. 09/110,717 filed Jul. 7, 1998; Ser. No. 60/053,378 filed Jul. 22, 1997; Ser. No. 60/068,913 filed Dec. 29, 1997; Ser. No. 60/090,239 filed Jun. 22, 1998; Ser. No. 09/009,455 filed Jan. 20, 1998; Ser. No. 09/110,678 filed Jul. 7, 1998; Ser. No. 60/053,307 filed Jul. 22, 1997; Ser. No. 60/068,918 filed Dec. 29, 1997; Ser. No. 60/080,725 filed Apr. 3, 1998; Ser. No. 09/181,180 filed Oct. 28, 1998; Ser. No. 60/063,451 filed Oct. 29, 1997; Ser. No. 09/008,947 filed Jan. 20, 1998; Ser. No. 60/074,006 filed Feb. 9, 1998; Ser. No. 60/080,647 filed Apr. 3, 1998; Ser. No. 09/009,837 filed Jan. 20, 1998; Ser. No. 08/822,170 filed Mar. 27, 1997; Ser. No. 08/592,712 filed Jan. 26, 1996; Ser. No. 08/467,051 filed on Jun. 6, 1995; Ser. No. 08/416,040 filed on Apr. 3, 1995; Ser. No. 08/467,911 filed on Jun. 6, 1995; Ser. No. 08/107,357 filed on Aug. 16, 1993; Ser. No. 08/075,102 filed on Jun. 11, 1993; Ser. No. 07/626,496 filed on Dec. 12, 1990; Ser. No. 07/345,628 filed Apr. 28, 1989; Ser. No. 07/341,733 filed Apr. 21, 1989 the entire disclosures of which are all incorporated herein by reference (hereinafter “Mills Prior Publications”). The binding energy, of an atom, ion or molecule, also known as the ionization energy, is the energy required to remove one electron from the atom, ion or molecule.

A hydrogen atom having the binding energy given in Eq. (1) is hereafter referred to as a hydrino atom or hydrino. The designation for a hydrino of radius

$$\frac{{a}_{H}}{p} ,$$

where a_{H} is the radius of an ordinary hydrogen atom and p is an integer, is

$$H [ \frac{{a}_{H}}{p} ] .$$

A hydrogen atom with a radius a_{H} is hereinafter referred to as “ordinary hydrogen atom” or “normal hydrogen atom.” Ordinary atomic hydrogen is characterized by its binding energy of 13.6 eV.

Hydrinos are formed by reacting an ordinary hydrogen atom with a catalyst having a net enthalpy of reaction of about

m·27.2 eV (2)

where m is an integer. This catalyst has also been referred to as an energy hole or source of energy hole in Mills earlier filed patent applications. It is believed that the rate of catalysis is increased as the net enthalpy of reaction is more closely matched to m·27.2 eV. It has been found that catalysts having a net enthalpy of reaction within ±10%, preferably ±5%, of m·27.2 eV are suitable for most applications.

This catalysis releases energy from the hydrogen atom with a commensurate decrease in size of the hydrogen atom, rₙ=na_{H}. For example, the catalysis of H(n=1) to H(n=1/2) releases 40.8 eV, and the hydrogen radius decreases from a_{H} to

$$\frac{1}{2} {a}_{H} .$$

A catalytic system is provided by the ionization of t electrons from an atom each to a continuum energy level such that the sum of the ionization energies of the t electrons is approximately m×27.2 eV where m is an integer. One such catalytic system involves potassium metal. The first, second, and third ionization energies of potassium are 4.34066 eV, 31.63 eV, 45.806 eV, respectively [D. R. Linde, CRC Handbook of Chemistry and Physics, 78 th Edition, CRC Press, Boca Raton, Fla., (1997), p. 10-214 to 10-216]. The triple ionization (t=3) reaction of K to K³⁺, then, has a net enthalpy of reaction of 81.7426 eV, which is equivalent to m=3 in Eq. (2).

$$\begin{matrix}81.7426 eV + K ( m ) + H [ \frac{{a}_{H}}{p} ] -> {K}^{3 +} + 3 {e}^{-} + H [ \frac{{a}_{H}}{( p + 3 )} ] + [ {( p + 3 )}^{2} - {p}^{2} ] \times 13.6 eV & ( 3 ) \\ {K}^{3 +} + 3 {e}^{-} -> K ( m ) + 81.7426 eV & ( 4 )\end{matrix}$$

And, the overall reaction is

$$H [ \frac{{a}_{H}}{p} ] -> H [ \frac{{a}_{H}}{( p + 3 )} ] + [ {( p + 3 )}^{2} - {p}^{2} ] \times 13.6 eV \qquad ( 5 )$$

Potassium ions can also provide a net enthalpy of a multiple of that of the potential energy of the hydrogen atom. The second ionization energy of potassium is 31.63 eV; and K⁺ releases 4.34 eV when it is reduced to K. The combination of reactions K⁺ to K²⁺ and K⁺ to K, then, has a net enthalpy of reaction of 27.28 eV, which is equivalent to m=1 in Eq. (2).

$$\begin{matrix}27.28 eV + {K}^{+} + {K}^{+} + H [ \frac{{a}_{H}}{p} ] -> K + {K}^{2 +} + H [ \frac{{a}_{H}}{( p + 1 )} ] + [ {( p + 1 )}^{2} - {p}^{2} ] \times 13.6 eV & ( 6 ) \\ K + {K}^{2 +} \to {K}^{+} + {K}^{+} + 27.28 eV & ( 7 )\end{matrix}$$

The overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 8 )$$

Rubidium ion (Rb⁺) is also a catalyst because the second ionization energy of rubidium is 27.28 eV. In this case, the catalysis reaction is

$$\begin{matrix}27.28 eV + {Rb}^{+} + H [ \frac{{a}_{H}}{p} ] \to {Rb}^{2 +} + {e}^{-} + H [ \frac{{a}_{H}}{( p + 1 )} ] + [ {( p + 1 )}^{2} - {p}^{2} ] X 13.6 eV & ( 9 ) \\ {Rb}^{2 +} + {e}^{-} \to {Rb}^{+} + 27.28 eV & ( 10 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 11 )$$

Helium ion (He⁺) is also a catalyst because the second ionization energy of helium is 54.417 eV. In this case, the catalysis reaction is

$$\begin{matrix}54.417 eV + {He}^{+} + H [ \frac{{a}_{H}}{p} ] \to {He}^{2 +} + {e}^{-} + H [ \frac{{a}_{H}}{( p + 2 )} ] + [ {( p + 2 )}^{2} - {p}^{2} ] X 13.6 eV & ( 12 ) \\ {He}^{2 +} + {e}^{-} \to {He}^{+} + 54.417 eV & ( 13 )\end{matrix}$$

And, the overall reaction is

$$H [ \frac{{a}_{H}}{p} ] \to H [ \frac{{a}_{H}}{( p + 2 )} ] + [ {( p + 2 )}^{2} - {p}^{2} ] X 13.6 eV \qquad ( 14 )$$

Argon ion is a catalyst. The second ionization energy is 27.63 eV.

$$\begin{matrix}27.63 eV + {Ar}^{+} + H [ \frac{{a}_{H}}{p} ] \to {Ar}^{2 +} + {e}^{-} + H [ \frac{{a}_{H}}{( p + 1 )} ] + [ {( p + 1 )}^{2} - {p}^{2} ] X 13.6 eV & ( 15 ) \\ {Ar}^{2 +} + {e}^{-} \to {Ar}^{+} + 27.63 eV & ( 16 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 17 )$$

An argon ion and a proton can also provide a net enthalpy of a multiple of that of the potential energy of the hydrogen atom. The third ionization energy of argon is 40.74 eV, and H⁺ releases 13.6 eV when it is reduced to H. The combination of reactions of Ar²⁺ to Ar³⁺ and H⁺ to H, then, has a net enthalpy of reaction of 27.14 eV, which is equivalent to m=1 in Eq. (2).

$$\begin{matrix}27.14 eV + {Ar}^{2 +} + {H}^{+} + H [ \frac{{a}_{H}}{p} ] \to H + {Ar}^{3 +} + H [ \frac{{a}_{H}}{( p + 1 )} ] + [ {( p + 1 )}^{2} - {p}^{2} ] X 13.6 eV & ( 18 ) \\ H + {Ar}^{3 +} \to {H}^{+} + {Ar}^{2 +} + 27.14 eV & ( 19 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 20 )$$

An neon ion and a proton can also provide a net enthalpy of a multiple of that of the potential energy of the hydrogen atom. The second ionization energy of neon is 40.96 eV, and H⁺ releases 13.6 eV when it is reduced to H. The combination of reactions of Ne⁺ to Ne²⁺ and H⁺ to H, then, has a net enthalpy of reaction of 27.36 eV, which is equivalent to m=1 in Eq. (2).

$$\begin{matrix}27.36 eV + {Ne}^{+} + {H}^{+} + H [ \frac{{a}_{H}}{p} ] \to H + {Ne}^{2 +} + H [ \frac{{a}_{H}}{( p + 1 )} ] + [ {( p + 1 )}^{2} - {p}^{2} ] X 13.6 eV & ( 21 ) \\ H + {Ne}^{2 +} \to {H}^{+} + {Ne}^{+} + 27.36 eV & ( 22 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 23 )$$

The energy given off during catalysis is much greater than the energy lost to the catalyst. The energy released is large as compared to conventional chemical reactions. For example, when hydrogen and oxygen gases undergo combustion to form water

$${H}_{2} ( g ) + \frac{1}{2} {O}_{2} ( g ) {H}_{2} O ( l ) \qquad ( 24 )$$

the known enthalpy of formation of water is ΔH_{f}=−286 kJ/mole or 1.48 eV per hydrogen atom. By contrast, each (n=1) ordinary hydrogen atom undergoing catalysis releases a net of 40.8 eV. Moreover, further catalytic transitions may occur:

$$n = \frac{1}{2} \to \frac{1}{3} , \frac{1}{3} \to \frac{1}{4} , \frac{1}{4} \to \frac{1}{5} ,$$

and so on. Once catalysis begins, hydrinos autocatalyze further in a process called disproportionation. This mechanism is similar to that of an inorganic ion catalysis. But, hydrino catalysis should have a higher reaction rate than that of the inorganic ion catalyst due to the better match of the enthalpy to m·27.2 eV.

### 2. Disproportionation

Lower-energy hydrogen atoms, “hydrinos”, may be generated by the catalysis of atomic hydrogen by a catalyst such as at least one of the catalysts given in Eqs. (3-23). The catalyzed lower energy hydrogen atom may serve as a reactant of a disproportionation reaction whereby it which accepts energy from an second catalyzed lower energy hydrogen atom to cause a further release of energy as the first atom undergoes a nonradiative electronic transition to a higher energy level while the second undergoes a transition to a lower energy level.

### 3. Novel Hydrogen Compounds

Lower energy atomic hydrogen may react to form a compound comprising

(a) at least one neutral, positive, or negative increased binding energy hydrogen species having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions, or is negative; and

(b) at least one other element.

### III. BRIEF DESCRIPTION OF THE DRAWINGS

FIG. 1. Capillary discharge vessel.

FIG. 2. Experimental setup for capillary discharge measurements.

FIG. 3. Cross sectional view of the LSP-VUV 1-3S-M portable EUV grazing incidence spectrometer.

FIG. 4. Spectrum of a capillary discharge.

FIG. 5. Cross sectional view of the BLP discharge cell.

FIG. 6. Experimental setup for the BLP discharge measurements.

FIG. 7. Standard microwave discharge emission spectrum of hydrogen (900-1700 Å) recorded on the McPherson model 302 (Seya-Namioka type) EUV spectrometer.

FIG. 8. The intensity of the scanned film 24 and the identified spectral lines recorded on the LSP-VUV 1-3S-M portable EUV grazing incidence spectrometer.

FIG. 9. The intensity of the scanned film 28 and the identified spectral lines recorded on the LSP-VUV 1-3S-M portable EUV grazing incidence spectrometer.

FIG. 10. The intensity of the scanned film 29 and the identified spectral lines recorded on the LSP-VUV 1-3S-M portable EUV grazing incidence spectrometer.

FIG. 11. The intensity of the scanned film 30 and the identified spectral lines recorded on the LSP-VUV 1-3S-M portable EUV grazing incidence spectrometer.

FIG. 12. The intensity of the scanned film 37 and the identified spectral lines recorded on the LSP-VUV 1-3S-M portable EUV grazing incidence spectrometer.

### IV. DETAILED DESCRIPTION OF THE INVENTION

### 1. Catalysts

The above objectives and other objectives are achieved by the present invention of a catalytic reaction of hydrogen to form more stable atomic hydrogen than uncatalyzed hydrogen which may serve as reactants to form lower energy hydrogen of further stability to provide a light, plasma, power, and novel hydrogen compound source. The light, plasma, power, and novel hydrogen compound source comprises a cell for the catalysis of atomic hydrogen to form novel hydrogen species and compositions of matter comprising new forms of hydrogen.

In an embodiment, a catalytic system is provided by the ionization of t electrons from a participating species such as an atom, an ion, a molecule, and an ionic or molecular compound to a continuum energy level such that the sum of the ionization energies of the t electrons is approximately m×27.2 eV where m is an integer. One such catalytic system involves cesium. The first and second ionization energies of cesium are 3.89390 eV and 23.15745 eV, respectively [David R. Linde, CRC Handbook of Chemistry and Physics, 74 th Edition, CRC Press, Boca Raton, Fla., (1993), p. 10-207]. The double ionization (t=2) reaction of Cs to Cs²⁺, then, has a net enthalpy of reaction of 27.05135 eV, which is equivalent to m=1 in Eq. (2).

$$\begin{matrix}27.05135 eV + Cs ( m ) + H [ \frac{{a}_{H}}{p} ] \to {Cs}^{2 +} + 2 {e}^{-} + H [ \frac{{a}_{H}}{( p + 1 )} ] + [ {( p + 1 )}^{2} - {p}^{2} ] X 13.6 eV & ( 25 ) \\ {Cs}^{2 +} + 2 {e}^{-} \to Cs ( m ) + 27.05135 eV & ( 26 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 27 )$$

Thermal energies may broaden the enthalpy of reaction. The relationship between kinetic energy and temperature is given by

$${E}_{kinetic} = \frac{3}{2} kT \qquad ( 28 )$$

For a temperature of 1200 K, the thermal energy is 0.16 eV, and the net enthalpy of reaction provided by cesium metal is 27.21 eV which is an exact match to the desired energy.

Hydrogen catalysts capable of providing a net enthalpy of reaction of approximately m×27.2 eV where m is an integer to produce hydrino whereby t electrons are ionized from an atom or ion are given infra. A further product of the catalysis is energy. The atoms or ions given in the first column are ionized to provide the net enthalpy of reaction of m×27.2 eV given in the tenth column where m is given in the eleventh column. The electrons which are ionized are given with the ionization potential (also called ionization energy or binding energy). The ionization potential of the nth electron of the atom or ion is designated by IPₙ and is given by David R. Linde, CRC Handbook of Chemistry and Physics, 78 th Edition, CRC Press, Boca Raton, Fla., (1997), p. 10-214 to 10-216 which is herein incorporated by reference. That is for example, Cs+3.89390 eV→Cs⁺+e⁻ and Cs⁺+23.15745 eV→Cs²⁺+e⁻. The first ionization potential, IP₁=3.89390 eV, and the second ionization potential, IP₂=23.15745 eV, are given in the second and third columns, respectively. The net enthalpy of reaction for the double ionization of Cs is 27.05135 eV as given in the tenth column, and m=1 in Eq. (2) as given in the eleventh column.

TABLE 1
Hydrogen Catalysts

| Catalyst | IP1 | IP2 | IP3 | IP4 | IP5 | IP6 | IP7 | IP8 | Enthalpy | m |
|---|---|---|---|---|---|---|---|---|---|---|
| Li | 5.39172 | 75.6402 | | | | | | | 81.032 | 3 |
| Be | 9.32263 | 18.2112 | | | | | | | 27.534 | 1 |
| K | 4.34066 | 81.63 | 45.806 | | | | | | 81.777 | 3 |
| Ca | 6.11316 | 11.8717 | 50.9131 | 67.27 | | | | | 136.17 | 5 |
| Ti | 6.8282 | 13.5755 | 27.4917 | 43.267 | 99.3 | | | | 190.46 | 7 |
| V | 6.7463 | 14.66 | 29.311 | 46.709 | 65.2817 | | | | 162.71 | 6 |
| Cr | 6.76664 | 16.4857 | 30.96 | | | | | | 54.212 | 2 |
| Mn | 7.43402 | 15.64 | 33.668 | 51.2 | | | | | 107.94 | 4 |
| Fe | 7.9024 | 16.1878 | 30.652 | | | | | | 54.742 | 2 |
| Fe | 7.9024 | 16.1878 | 30.652 | 54.8 | | | | | 109.54 | 4 |
| Co | 7.881 | 17.083 | 33.5 | 51.3 | | | | | 109.76 | 4 |
| Co | 7.881 | 17.083 | 33.5 | 51.3 | 79.5 | | | | 189.26 | 7 |
| Ni | 7.6398 | 18.1688 | 35.19 | 54.9 | 76.06 | | | | 191.96 | 7 |
| Ni | 7.6398 | 18.1688 | 35.19 | 54.9 | 76.06 | 108 | | | 299.96 | 11 |
| Cu | 7.72638 | 20.2924 | | | | | | | 28.019 | 1 |
| Zn | 9.39405 | 17.9644 | | | | | | | 27.358 | 1 |
| Zn | 9.39405 | 17.9644 | 89.723 | 59.4 | 82.6 | 108 | 134 | 174 | 625.08 | 23 |
| As | 9.8152 | 18.633 | 28.351 | 50.13 | 62.63 | 127.6 | | | 297.16 | 11 |
| Se | 9.75238 | 21.19 | 30.8204 | 42.945 | 68.3 | 81.7 | 155.4 | | 410.11 | 15 |
| Kr | 13.9996 | 24.3599 | 36.95 | 52.5 | 64.7 | 78.5 | | | 271.01 | 10 |
| Kr | 13.9996 | 24.3599 | 36.95 | 52.5 | 64.7 | 78.5 | 111 | | 382.01 | 14 |
| Rb | 4.17713 | 27.285 | 40 | 52.6 | 71 | 84.4 | 99.2 | | 378.66 | 14 |
| Rb | 4.17713 | 27.285 | 40 | 52.6 | 71 | 84.4 | 99.2 | 136 | 514.66 | 19 |
| Sr | 5.69484 | 11.0301 | 42.89 | 57 | 71.6 | | | | 188.21 | 7 |
| Nb | 6.75885 | 14.32 | 25.04 | 38.3 | 50.55 | | | | 134.97 | 5 |
| Mo | 7.09243 | 16.16 | 27.13 | 46.4 | 54.49 | 68.8276 | | | 151.27 | 8 |
| Mo | 7.09243 | 16.16 | 27.13 | 46.4 | 54.49 | 68.8276 | 125.664 | 143.6 | 489.36 | 18 |
| Pd | 8.3369 | 19.43 | | | | | | | 27.767 | 1 |
| Sn | 7.34381 | 14.6323 | 30.5026 | 40.735 | 72.28 | | | | 165.49 | 6 |
| Te | 9.0096 | 18.6 | | | | | | | 27.61 | 1 |
| Te | 9.0096 | 18.6 | 27.96 | | | | | | 55.57 | 2 |
| Cs | 3.8939 | 23.1575 | | | | | | | 27.051 | 1 |
| Ce | 5.5387 | 10.85 | 20.198 | 36.758 | 65.55 | | | | 138.89 | 5 |
| Ce | 5.5387 | 10.85 | 20.198 | 36.758 | 65.55 | 77.6 | | | 216.49 | 8 |
| Pr | 5.464 | 10.55 | 21.624 | 38.98 | 57.53 | | | | 134.15 | 5 |
| Sm | 5.6437 | 11.07 | 23.4 | 41.4 | | | | | 81.514 | 3 |
| Gd | 6.15 | 12.09 | 20.63 | 44 | | | | | 82.87 | 3 |
| Dy | 5.9389 | 11.67 | 22.8 | 41.47 | | | | | 81.879 | 3 |
| Pb | 7.41666 | 15.0322 | 31.9373 | | | | | | 54.386 | 2 |
| Pt | 8.9587 | 18.563 | | | | | | | 27.522 | 1 |
| He+ | | 54.4178 | | | | | | | 54.418 | 2 |
| Na+ | | 47.2864 | 71.6200 | 98.91 | | | | | 217.816 | 8 |
| Rb+ | | 27.285 | | | | | | | 27.285 | 1 |
| Fe3+ | | | | 54.8 | | | | | 54.8 | 2 |
| Mo2+ | | | 27.13 | | | | | | 27.13 | 1 |
| Mo4+ | | | | | 54.49 | | | | 54.49 | 2 |
| In3+ | | | | 54 | | | | | 54 | 2 |
| Xe+ | | 21.2097 | [symbol] 2.1230 | | | | | | 53.33279 | 2 |

[symbol]

indicates data missing or illegible when filed

### 2. Disproportionation

Lower-energy hydrogen atoms, “hydrinos”, may be generated by the catalysis of atomic hydrogen by a catalyst such as at least one of the catalysts given in Table 1. The catalyzed lower energy hydrogen atom may serve as a reactant of a disproportionation reaction whereby it which accepts energy from an second catalyzed lower energy hydrogen atom to cause a further release of energy as the first atom undergoes a nonradiative electronic transition to a higher energy level while the second undergoes a transition to a lower energy level. Lower-energy hydrogen atoms, “hydrinos”, can act as reactants to cause electronic transitions of atomic hydrogen with a further release of energy because each of the metastable excitation, resonance excitation, and ionization energy of a hydrino atom is m×27.2 eV (Eq. (2)). The transition reaction mechanism of a first hydrino atom affected by a second hydrino atom involves the resonant coupling between the atoms of m degenerate multipoles each having 27.21 eV of potential energy [Mills GUT]. The energy transfer of m×27.2 eV from the first hydrino atom to the second hydrino atom causes the central field of the first atom to increase by m and its electron to drop m levels lower from a radius of

$$\frac{{a}_{H}}{p}$$

to a radius of

$$\frac{{a}_{H}}{p + m} .$$

The second interacting lower-energy hydrogen is either excited to a metastable state, excited to a resonance state, or ionized by the resonant energy transfer. The resonant transfer may occur in multiple stages. For example, a nonradiative transfer by multipole coupling may occur wherein the central field of the first increases by m, then the electron of the first drops m levels lower from a radius of

$$\frac{{a}_{H}}{p}$$

to a radius of

$$\frac{{a}_{H}}{p + m}$$

with further resonant energy transfer. The energy transferred by multipole coupling may occur by a mechanism that is analogous to photon absorption involving an excitation to a virtual level. Or, the energy transferred by multipole coupling and during the electron transition of the first hydrino atom may occur by a mechanism that is analogous to two photon absorption involving a first excitation to a virtual level and a second excitation to a resonant or continuum level [Thompson, B. J., Handbook of Nonlinear Optics, Marcel Dekker, Inc., New York, (1996), pp. 497-548; Shen, Y. R., The Principles of Nonlinear Optics, John Wiley & Sons, New York, (1984), pp. 203-210; B. de Beauvoir, F. Nez, L. Julien, B. Cagnac, F. Biraben, D. Touahri, L. Hilico, O. Acef, A. Clairon, and J. J. Zondy, Physical Review Letters, Vol. 78, No. 3, (1997), pp. 440-443]. The transition energy greater than the energy transferred to the second hydrino atom may appear as a photon in a vacuum medium.

For example, the transition of

$$H [ \frac{{a}_{H}}{p} ] to H [ \frac{{a}_{H}}{p + m} ]$$

induced by a resonance transfer of m·27.21 eV (Eq. (2)) with a metastable state excited in

$$H [ \frac{{a}_{H}}{{p}^{′}} ]$$

is represented by

$$\begin{matrix}m \cdot 27.2 eV + H [ \frac{{a}_{H}}{{p}^{′}} ] + H [ \frac{{a}_{H}}{p} ] \to {H}^{*} [ \frac{{a}_{H}}{{p}^{′}} ] + H [ \frac{{a}_{H}}{p + m} ] + [ {( p + m )}^{2} - {p}^{2} ] \times 13.6 eV & ( 29 ) \\ {H}^{*} [ \frac{{a}_{H}}{{p}^{′}} ] \to H [ \frac{{a}_{H}}{{p}^{′}} ] + m \cdot 27.2 eV & ( 30 )\end{matrix}$$

And, the overall reaction is

$$H [ \frac{{a}_{H}}{p} ] \to H [ \frac{{a}_{H}}{p + m} ] + [ {( p + m )}^{2} - {p}^{2} ] \times 13.6 eV \qquad ( 31 )$$

where p, p′, and m are integers and the asterisk represents an excited metastable state.

The transition of

$$H [ \frac{{a}_{H}}{p} ] to H [ \frac{{a}_{H}}{p + m} ]$$

induced by a multipole resonance transfer of m·27.21 eV (Eq. (2)) and a transfer of [(p′)²−(p′−m′)²]×13.6 eV−m·27.2 eV with a resonance state of

$$H [ \frac{{a}_{H}}{{p}^{′} - {m}^{′}} ]$$

excited in

$$H [ \frac{{a}_{H}}{{p}^{′}} ]$$

is represented by

$$H [ \frac{{a}_{H}}{{p}^{′}} ] + H [ \frac{{a}_{H}}{p} ] \to H [ \frac{{a}_{H}}{{p}^{′} - {m}^{′}} ] + H [ \frac{{a}_{H}}{p + m} ] + [ ( {( p + m )}^{2} - {p}^{2} ) - ( {p}^{′2} - {( {p}^{′} - {m}^{′} )}^{2} ) ] \times 13.6 eV \qquad ( 32 )$$

where p, p′, m, and m′ are integers.

The second lower-energy hydrogen may be ionized by the resonant nonradiative energy transfer of an integer multiple of 27.21 eV. The transition cascade for the pth cycle of the hydrogen-type atom,

$$H [ \frac{{a}_{H}}{p} ] ,$$

with the hydrogen-type atom,

$$H [ \frac{{a}_{H}}{{m}^{′}} ] ,$$

that is ionized as the source of a net enthalpy of reaction of m×27.2 eV (Eq. (2)) that causes the transition is represented by

$$\begin{matrix}mX 27.21 eV + H [ \frac{{a}_{H}}{{m}^{′}} ] + H [ \frac{{a}_{H}}{p} ] \to {H}^{+} + {e}^{-} + H [ \frac{{a}_{H}}{( p + m )} ] + [ {( p + m )}^{2} - {p}^{2} - ( {m}^{′2} - 2 m ) ] \times 13.6 eV & ( 33 ) \\ {H}^{+} + {e}^{-} \to H [ \frac{{a}_{H}}{1} ] + 13.6 eV & ( 34 )\end{matrix}$$

And, the overall reaction is

$$H [ \frac{{a}_{H}}{{m}^{′}} ] + H [ \frac{{a}_{H}}{p} ] \to H [ \frac{{a}_{H}}{1} ] + H [ \frac{{a}_{H}}{( p + m )} ] + [ 2 pm + {m}^{2} - {m}^{′2} ] \times 13.6 eV + 13.6 eV \qquad ( 35 )$$

### 3. Catalysis of Hydrogen to Form Novel Hydrogen Species and Compositions of Matter Comprising New Forms of Hydrogen

The catalytic reaction of hydrogen forms novel hydrogen species and compositions of matter comprising new forms of hydrogen. The novel hydrogen compositions of matter comprise:

(a) at least one neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions (standard temperature and pressure, STP), or is negative; and

(b) at least one other element. The compounds of the invention are hereinafter referred to as “increased binding energy hydrogen compounds”.

By “other element” in this context is meant an element other than an increased binding energy hydrogen species. Thus, the other element can be an ordinary hydrogen species, or any element other than hydrogen. In one group of compounds, the other element and the increased binding energy hydrogen species are neutral. In another group of compounds, the other element and increased binding energy hydrogen species are charged such that the other element provides the balancing charge to form a neutral compound. The former group of compounds is characterized by molecular and coordinate bonding; the latter group is characterized by ionic bonding.

Also provided are novel compounds and molecular ions comprising

(a) at least one neutral, positive, or negative hydrogen species (hereinafter “increased binding energy hydrogen species”) having a total energy
(i) greater than the total energy of the corresponding ordinary hydrogen species, or
(ii) greater than the total energy of any hydrogen species for which the corresponding ordinary hydrogen species is unstable or is not observed because the ordinary hydrogen species' total energy is less than thermal energies at ambient conditions, or is negative; and

(b) at least one other element.

The total energy of the hydrogen species is the sum of the energies to remove all of the electrons from the hydrogen species. The hydrogen species according to the present invention has a total energy greater than the total energy of the corresponding ordinary hydrogen species. The hydrogen species having an increased total energy according to the present invention is also referred to as an “increased binding energy hydrogen species” even though some embodiments of the hydrogen species having an increased total energy may have a first electron binding energy less that the first electron binding energy of the corresponding ordinary hydrogen species. For example, the hydride ion of Eq. (36) for p=24 has a first binding energy that is less than the first binding energy of ordinary hydride ion, while the total energy of the hydride ion of Eq. (36) for p=24 is much greater than the total energy of the corresponding ordinary hydride ion.

Also provided are novel compounds and molecular ions comprising

(a) a plurality of neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions or is negative; and

(b) optionally one other element. The compounds of the invention are hereinafter referred to as “increased binding energy hydrogen compounds”.

The increased binding energy hydrogen species can be formed by reacting one or more hydrino atoms with one or more of an electron, hydrino atom, a compound containing at least one of said increased binding energy hydrogen species, and at least one other atom, molecule, or ion other than an increased binding energy hydrogen species.

Also provided are novel compounds and molecular ions comprising

(a) a plurality of neutral, positive, or negative hydrogen species (hereinafter “increased binding energy hydrogen species”) having a total energy
(i) greater than the total energy of ordinary molecular hydrogen, or
(ii) greater than the total energy of any hydrogen species for which the corresponding ordinary hydrogen species is unstable or is not observed because the ordinary hydrogen species' total energy is less than thermal energies at ambient conditions or is negative; and

(b) optionally one other element. The compounds of the invention are hereinafter referred to as “increased binding energy hydrogen compounds”.

The total energy of the increased total energy hydrogen species is the sum of the energies to remove all of the electrons from the increased total energy hydrogen species. The total energy of the ordinary hydrogen species is the sum of the energies to remove all of the electrons from the ordinary hydrogen species. The increased total energy hydrogen species is referred to as an increased binding energy hydrogen species, even though some of the increased binding energy hydrogen species may have a first electron binding energy less than the first electron binding energy of ordinary molecular hydrogen. However, the total energy of the increased binding energy hydrogen species is much greater than the total energy of ordinary molecular hydrogen.

In one embodiment of the invention, the increased binding energy hydrogen species can be Hₙ, and Hₙ⁻ where n is a positive integer, or Hₙ⁺ where n is a positive integer greater than one. Preferably, the increased binding energy hydrogen species is Hₙ and Hₙ⁻ where n is an integer from one to about 1×10⁶, more preferably one to about 1×10⁴, even more preferably one to about 1×10², and most preferably one to about 10, and Hₙ⁺ where n is an integer from two to about 1×10⁶, more preferably two to about 1×10⁴, even more preferably two to about 1×10², and most preferably two to about 10. A specific example of Hₙ⁻ is H₁₆⁻.

In an embodiment of the invention, the increased binding energy hydrogen species can be Hₙ^{m-} where n and m are positive integers and Hₙ^{m+} where n and m are positive integers with m<n. Preferably, the increased binding energy hydrogen species is Hₙ^{m-} where n is an integer from one to about 1×10⁶, more preferably one to about 1×10⁴, even more preferably one to about 1×10², and most preferably one to about 10 and m is an integer from one to 100, one to ten, and Hₙ^{m+} where n is an integer from two to about 1×10⁶, more preferably two to about 1×10⁴, even more preferably two to about 1×10², and most preferably two to about 10 and m is one to about 100, preferably one to ten.

According to a preferred embodiment of the invention, a compound is provided, comprising at least one increased binding energy hydrogen species selected from the group consisting of (a) hydride ion having a binding energy according to Eq. (36) that is greater than the binding of ordinary hydride ion (about 0.8 eV) for p=2 up to 23, and less for p=24 (“increased binding energy hydride ion” or “hydrino hydride ion”); (b) hydrogen atom having a binding energy greater than the binding energy of ordinary hydrogen atom (about 13.6 eV) (“increased binding energy hydrogen atom” or “hydrino”); (c) hydrogen molecule having a first binding energy greater than about 15.5 eV (“increased binding energy hydrogen molecule” or “dihydrino”); and (d) molecular hydrogen ion having a binding energy greater than about 16.4 eV (“increased binding energy molecular hydrogen ion” or “dihydrino molecular ion”).

The compounds of the present invention are capable of exhibiting one or more unique properties which distinguishes them from the corresponding compound comprising ordinary hydrogen, if such ordinary hydrogen compound exists. The unique properties include, for example, (a) a unique stoichiometry; (b) unique chemical structure; (c) one or more extraordinary chemical properties such as conductivity, melting point, boiling point, density, and refractive index; (d) unique reactivity to other elements and compounds; (e) enhanced stability at room temperature and above; and/or (f) enhanced stability in air and/or water. Methods for distinguishing the increased binding energy hydrogen-containing compounds from compounds of ordinary hydrogen include: 1.) elemental analysis, 2.) solubility, 3.) reactivity, 4.) melting point, 5.) boiling point, 6.) vapor pressure as a function of temperature, 7.) refractive index, 8.) X-ray photoelectron spectroscopy (XPS), 9.) gas chromatography, 10.) X-ray diffraction (XRD), 11.) calorimetry, 12.) infrared spectroscopy (IR), 13.) Raman spectroscopy, 14.) Mossbauer spectroscopy, 15.) extreme ultraviolet (EUV) emission and absorption spectroscopy, 16.) ultraviolet (UV) emission and absorption spectroscopy, 17.) visible emission and absorption spectroscopy, 18.) nuclear magnetic resonance spectroscopy, 19.) gas phase mass spectroscopy of a heated sample (solids probe and direct exposure probe quadrapole and magnetic sector mass spectroscopy), 20.) time-of-flight-secondary-ion-mass-spectroscopy (TOFSIMS), 21.) electrospray-ionization-time-of-flight-mass-spectroscopy (ESITOFMS), 22.) thermogravimetric analysis (TGA), 23.) differential thermal analysis (DTA), 24.) differential scanning calorimetry (DSC), 25.) liquid chromatography/mass spectroscopy (LCMS), 26.) neutron diffraction, and/or 27.) gas chromatography/mass spectroscopy (GCMS).

According to the present invention, a hydrino hydride ion (H⁻) having a binding energy according to Eq. (36) that is greater than the binding of ordinary hydride ion (about 0.8 eV) for p=2 up to 23, and less for p=24 (H⁻) is provided. For p=2 to p=24 of Eq. (36), the hydride ion binding energies are respectively 3, 6.6, 11.2, 16.7, 22.8, 29.3, 36.1, 42.8, 49.4, 55.5, 61.0, 65.6, 69.2, 71.5, 72.4, 715, 68.8, 64.0, 56.8, 47.1, 34.6, 19.2, and 0.65 eV. Compositions comprising the novel hydride ion are also provided.

The binding energy of the novel hydrino hydride ion can be represented by the following formula:

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e }^{2} {a}_{0}^{3}} ( 1 + \frac{{2}^{2}}{{[ \frac{1 + \sqrt{s ( s + 1 )}}{p} ]}^{3}} ) \qquad ( 36 )$$

where p is an integer greater than one, s=1/2, π is pi, is Planck's constant bar, μₒ is the permeability of vacuum, mₑ is the mass of the electron, μₑ is the reduced electron mass, aₒ is the Bohr radius, and e is the elementary charge. The radii are given by

$${r}_{2} = {r}_{1} = {a}_{0} ( 1 + \sqrt{s ( s + 1 )} ) ; s = \frac{1}{2} \qquad ( 37 )$$

The hydrino hydride ion of the present invention can be formed by the reaction of an electron source with a hydrino, that is, a hydrogen atom having a binding energy of about

$$\frac{13.6 eV}{{n}^{2}} ,$$

where

$$n = \frac{1}{p}$$

and p is an integer greater than 1. The hydrino hydride ion is represented by H⁻(n=1/p) or H⁻(1/p):

$$\begin{matrix}H [ \frac{{a}_{H}}{p} ] + {e}^{-} \to {H}^{-} ( n = 1 / p ) & ( 38 ) a \\ H [ \frac{{a}_{H}}{p} ] + {e}^{-} \to {H}^{-} ( 1 / p ) & ( 38 ) b\end{matrix}$$

The hydrino hydride ion is distinguished from an ordinary hydride ion comprising an ordinary hydrogen nucleus and two electrons having a binding energy of about 0.8 eV. The latter is hereafter referred to as “ordinary hydride ion” or “normal hydride ion” The hydrino hydride ion comprises a hydrogen nucleus including proteum, deuterium, or tritium, and two indistinguishable electrons at a binding energy according to Eq. (36).

The binding energies of the hydrino hydride ion, H⁻(n=1/p) as a function of p, where p is an integer, are shown in TABLE 2.

TABLE 2
The representative binding energy of the hydrino
hydride ion H⁻(n = 1/p) as a function of p, Eq. (36).

| Hydride Ion | r₁ | Binding | |
|---|---|---|---|
| (aₒ)^{a} | Energy (eV)^{b} | (nm) | Wavelength |
| H⁻(n = 1/2) | 0.9330 | 3.047 | 407 |
| H⁻(n = 1/3) | 0.6220 | 6.610 | 188 |
| H⁻(n = 1/4) | 0.4665 | 11.23 | 110 |
| H⁻(n = 1/5) | 0.3732 | 16.70 | 74.2 |
| H⁻(n = 1/6) | 0.3110 | 22.81 | 54.4 |
| H⁻(n = 1/7) | 0.2666 | 29.34 | 42.3 |
| H⁻(n = 1/8) | 0.2333 | 36.08 | 34.4 |
| H⁻(n = 1/9) | 0.2073 | 42.83 | 28.9 |
| H⁻(n = 1/10) | 0.1866 | 49.37 | 25.1 |
| H⁻(n = 1/11) | 0.1696 | 55.49 | 22.3 |
| H⁻(n = 1/12) | 0.1555 | 60.97 | 20.3 |
| H⁻(n = 1/13) | 0.1435 | 65.62 | 18.9 |
| H⁻(n = 1/14) | 0.1333 | 69.21 | 17.9 |
| H⁻(n = 1/15) | 0.1244 | 71.53 | 17.3 |
| H⁻(n = 1/16) | 0.1166 | 72.38 | 17.1 |
| H⁻(n = 1/17) | 0.1098 | 71.54 | 17.33 |
| H⁻(n = 1/18) | 0.1037 | 68.80 | 18.02 |
| H⁻(n = 1/19) | 0.0982 | 63.95 | 19.39 |
| H⁻(n = 1/20) | 0.0933 | 56.78 | 21.83 |
| H⁻(n = 1/21) | 0.0889 | 47.08 | 26.33 |
| H⁻(n = 1/22) | 0.0848 | 34.63 | 35.80 |
| H⁻(n = 1/23) | 0.0811 | 19.22 | 64.49 |
| H⁻(n = 1/24) | 0.0778 | 0.6535 | 1897 |

^{a}Equation (37)
^{b}Equation (36)

Novel compounds are provided comprising one or more hydrino hydride ions and one or more other elements. Such a compound is referred to as a hydrino hydride compound.

Ordinary hydrogen species are characterized by the following binding energies (a) hydride ion, 0.754 eV (“ordinary hydride ion”); (b) hydrogen atom (“ordinary hydrogen atom”), 13.6 eV; (c) diatomic hydrogen molecule, 15.46 eV (“ordinary hydrogen molecule”); (d) hydrogen molecular ion, 16.4 eV (“ordinary hydrogen molecular ion”); and (e) H₃⁺, 22.6 eV (“ordinary trihydrogen molecular ion”). Herein, with reference to forms of hydrogen, “normal” and “ordinary” are synonymous.

According to a further preferred embodiment of the invention, a compound is provided comprising at least one increased binding energy hydrogen species such as (a) a hydrogen atom having a binding energy of about

$$\frac{13.6 eV}{{( \frac{1}{p} )}^{2}} ,$$

preferably within ±10%, more preferably ±5%, where p is an integer, preferably an integer from 2 to 200; (b) a hydride ion (H⁻) having a binding energy of about

$$\frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} ) ,$$

preferably within ±10%, more preferably ±5%, where p is an integer, preferably an integer from 2 to 200, s=1/2, π is pi, is Planck's constant bar, μₒ is the permeability of vacuum, mₑ is the mass of the electron, μₑ is the reduced electron mass, aₒ is the Bohr radius, and e is the elementary charge; (c) H₄⁺(1/p); (d) a trihydrino molecular ion, H₃⁺(1/p), having a binding energy of about

$$\frac{22.6}{{( \frac{1}{p} )}^{2}} eV$$

preferably within ±10%, more preferably ±5%, where p is an integer, preferably an integer from 2 to 200; (e) a dihydrino having a binding energy of about

$$\frac{15.5}{{( \frac{1}{p} )}^{2}} eV$$

preferably within ±10%, more preferably ±5%, where p is an integer, preferably and integer from 2 to 200; (f) a dihydrino molecular ion with a binding energy of about

$$\frac{16.4}{{( \frac{1}{p} )}^{2}} eV$$

preferably within ±10%, more preferably ±5%, where p is an integer, preferably an integer from 2 to 200.

According to one embodiment of the invention wherein the compound comprises a negatively charged increased binding energy hydrogen species, the compound further comprises one or more cations, such as a proton, ordinary H₂⁺, or ordinary H₃⁺.

A method is provided for preparing compounds comprising at least one increased binding energy hydride ion. Such compounds are hereinafter referred to as “hydrino hydride compounds”. The method comprises reacting atomic hydrogen with a catalyst having a net enthalpy of reaction of about m/2·27 eV, where m is an integer greater than 1, preferably an integer less than 400, to produce an increased binding energy hydrogen atom having a binding energy of about

$$\frac{13.6 eV}{{( \frac{1}{p} )}^{2}}$$

where p is an integer, preferably an integer from 2 to 200. A further product of the catalysis is energy. The increased binding energy hydrogen atom can be reacted with an electron source, to produce an increased binding energy hydride ion. The increased binding energy hydride ion can be reacted with one or more cations to produce a compound comprising at least one increased binding energy hydride ion.

### 4. Hydride Reactor

The invention is also directed to a reactor for producing increased binding energy hydrogen compounds of the invention, such as hydrino hydride compounds. A further product of the catalysis is energy. Such a reactor is hereinafter referred to as a “hydrino hydride reactor”. The hydrino hydride reactor comprises a cell for making hydrinos and an electron source. The reactor produces hydride ions having the binding energy of Eq. (36). The cell for making hydrinos may take the form of a gas cell, a gas discharge cell, or a plasma torch cell, for example. Each of these cells comprises: a source of atomic hydrogen; at least one of a solid, molten, liquid, or gaseous catalyst for making hydrinos; and a vessel for reacting hydrogen and the catalyst for making hydrinos. As used herein and as contemplated by the subject invention, the term “hydrogen”, unless specified otherwise, includes not only proteum (¹H), but also deuterium (²H) and tritium (³H). Electrons from the electron source contact the hydrinos and react to form hydrino hydride ions.

The reactors described herein as “hydrino hydride reactors” are capable of producing not only hydrino hydride ions and compounds, but also the other increased binding energy hydrogen compounds of the present invention. Hence, the designation “hydrino hydride reactors” should not be understood as being limiting with respect to the nature of the increased binding energy hydrogen compound produced.

According to one aspect of the present invention, novel compounds are formed from hydrino hydride ions and cations. In the gas cell, the cation can be an oxidized species of the material of the cell, a cation comprising the molecular hydrogen dissociation material which produces atomic hydrogen, a cation comprising an added reductant, or a cation present in the cell (such as a cation comprising the catalyst). In the discharge cell, the cation can be an oxidized species of the material of the cathode or anode, a cation of an added reductant, or a cation present in the cell (such as a cation comprising the catalyst). In the plasma torch cell, the cation can be either an oxidized species of the material of the cell, a cation of an added reductant, or a cation present in the cell (such as a cation comprising the catalyst).

### 5. Data

A high voltage discharge of hydrogen with and without the presence of a source of potassium, potassium iodide, in the discharge was performed with a hollow cathode at the Institut Fur Niedertemperatur-Plasmaphysik e.V. [R. Mills, “Observation of Extreme Ultraviolet Emission from Hydrogen-KI Plasmas Produced by a Hollow Cathode Discharge”, Int. J. Hydrogen Energy, in press, “Mills-INP”] which is herein incorporated by reference. It has been reported that intense extreme ultraviolet (EUV) emission was observed from atomic hydrogen and certain elements or certain ions which ionize at integer multiples of the potential energy of atomic hydrogen, 27.2 eV [R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943 which is incorporated herein by reference]. Two potassium ions or a potassium atom may each provide an electron ionization or transfer reaction that has a net enthalpy equal to an integer multiple of 27.2 eV. In the Mills-INP study, the spectral lines of atomic hydrogen were intense enough to be recorded on photographic films only when KI was present. EUV lines not assignable to potassium, iodine, or hydrogen shown in TABLE 3 were observed at 73.0, 132.6, 513.6, 677.8, 885.9, and 1032.9 Å. The lines could be assigned to transitions of atomic hydrogen to lower energy levels corresponding to lower energy hydrogen atoms called hydrino atoms and the emission from the excitation of the corresponding hydride ions formed from the hydrino atoms.

TABLE 3
Observed emission data from hydrogen-KI plasmas produced by
a hollow cathode discharge that can not be assigned to
atomic or molecular hydrogen.

| | | Observed | Ob- | | Pre- | Prediected |
|---|---|---|---|---|---|---|
| | INP | Wave- | served | | dicted | Wave- |
| | Peak | length | Energy | Peak | Energy | length |
| Peak | # | (Å) | (eV) | Assignment | (eV) | (Å) |
| 1 | #24, | 73.0 | 169.9 | 1/4 → 1/6 H | 176.8 | 70.2 |
| (in- | #30 | | | transition^{a} | | |
| side) | | | | | | |
| 3 | #30 | 1032.9 | 12.0 | H ⁻(1/4)^{b, c} | 11.23 | 1104 |
| 19 | #28 | 132.6 | 93.5 | 1/4 → 1/5 H | 95.2 | 130.3 |
| | | | | transition^{d} | | |
| 20 | #28 | 885.9 | 14.0 | $\begin{matrix}Inelastic H \\ scattering of \\ H * {[ \frac{{a}_{H}}{4} ]}^{e}\end{matrix}$ | 13.98 | 887.2 |
| 21 | #30 | 513.6 | 25.15 | H ⁻(1/6)^{c} | 22.8 | 543 |
| 22 | #30 | 677.8 | 18.30 | H ⁻(1/5)^{c} | 16.7 | 742 |

^{a}Transition induced by a resonance state excited in
$\begin{matrix}H [ \frac{{a}_{H}}{4} ] \\ H [ \frac{{a}_{H}}{4} ] + H [ \frac{{a}_{H}}{4} ] \to H [ \frac{{a}_{H}}{6} ] + H [ \frac{{a}_{H}}{3} ] + 176.8 eV\end{matrix}$
^{b}I⁺has a peak at 1034.66 Å, [31] but none of the other iodine lines were
detected including much stronger lines.
^{c}The hydride ion emission is anticipated to be shift to shorter wavelengths
due to its presence in a chemical compound.
^{d}Transition induced by a metastable state excited in
$\begin{matrix}H [ \frac{{a}_{H}}{4} ] \\ 27.2 eV + H [ \frac{{a}_{H}}{4} ] + H [ \frac{{a}_{H}}{4} ] \to H * [ \frac{{a}_{H}}{4} ] + H * [ \frac{{a}_{H}}{5} ] + 27.2 eV + 95.2 eV \\ H * [ \frac{{a}_{H}}{4} ] \to H [ \frac{{a}_{H}}{4} ] + 27.2 eV \\ H [ \frac{{a}_{H}}{4} ] \to H [ \frac{{a}_{H}}{5} ] + 95.2 eV + 27.2 eV\end{matrix}$
${}^{e} Hydrogen inelastic scattered peak of H * [ \frac{{a}_{H}}{4} ] deexcitation$
$H * [ \frac{{a}_{H}}{4} ] + H ( n = 1 ; {m}_{l} = 0 ) \to H [ \frac{{a}_{H}}{4} ] + H ( n = 6 ; {m}_{l} = 5 ) + 13.98 eV$

The results support that potassium atoms reacted with atomic hydrogen to form novel hydrogen energy states. Potassium iodide present in the discharge of hydrogen served as a source of potassium metal which was observed to collect on the walls of the cell during operation. According to Eqs. (3-5), potassium metal reacts with atomic hydrogen present in the discharge and forms the hydrino atom

$$H [ \frac{{a}_{H}}{4} ] .$$

The energy released was expected to undergo internal conversion to increase the brightness of the plasma discharge since this is the common mechanism of relaxation. This is consistent with observation.

The product,

$$H [ \frac{{a}_{H}}{4} ]$$

may serve as a reactant to form

$$H [ \frac{{a}_{H}}{5} ]$$

according to Eqs. (29-31). The transition of

$$H [ \frac{{a}_{H}}{4} ] to H [ \frac{{a}_{H}}{5} ]$$

induced by a resonance transfer of 27.21 eV, m=1 in Eq. (2) with a metastable state excited in

$$H [ \frac{{a}_{H}}{4} ]$$

is represented by

$$\begin{matrix}27.2 eV + H [ \frac{{a}_{H}}{4} ] + H [ \frac{{a}_{H}}{4} ] \to H * [ \frac{{a}_{H}}{4} ] + H [ \frac{{a}_{H}}{5} ] + 2.7 .2 eV + 95.2 eV & ( 39 ) \\ H * [ \frac{{a}_{H}}{4} ] \to H [ \frac{{a}_{H}}{4} ] + 27.2 eV & ( 40 ) \\ H [ \frac{{a}_{H}}{4} ] \to H [ \frac{{a}_{H}}{5} ] + 95.2 eV + 27.2 eV & ( 41 )\end{matrix}$$

The energy emitted by a hydrino which has nonradiatively transferred m×27.2 eV of energy to a second hydrino may be emitted as a spectral line. Hydrinos may accept energy by a nonradiative mechanism [Mills GUT]; thus, rather than suppressing the emission through internal conversion they do not interact with the emitted radiation. The predicted 95.2 eV (130.3 Å) photon (peak #19) shown in FIG. 29 of Mills-INP is a close match with the observed 132.6 Å line. In FIG. 29 of Mills-INP, an additional peak (peak #20) was observed at 885.9 Å. It is proposed that peak #20 of Mills-INP arises from inelastic hydrogen scattering of the metastable state

$$H * [ \frac{{a}_{H}}{4} ]$$

formed by the resonant nonradiative energy transfer of 27.2 eV from a first

$$H [ \frac{{a}_{H}}{4} ]$$

atom to a second as shown in Eq. (39). The metastable state then nonradiatively transfers part of the 27.2 eV excitation energy to excite atomic hydrogen initially in the state 1s ²S_{1/2} to the state 6h ²H_{11/2}. This leaves a 13.98 eV (887.2 Å) photon, peak 20. The initial and final states for all hydrogen species and emitted photons are determined by the selection rule for conservation of angular momentum where the 13.98 eV photon corresponds to mₗ=0 and the initial and final states for the hydrino atom reactants correspond to mₗ=3 and mₗ=−2, respectively. In the case that the 95.2 eV (130.3 Å) photon (peak #19) corresponds to mₗ=0 or ±1, then angular momentum is conserved. The excited state hydrogen may then emit hydrogen lines that are observed in FIG. 29 of Mills-INP. Thus, the inelastic hydrogen scattering of the deexcitation of

$$H * [ \frac{{a}_{H}}{4} ] may be represented by \\ H * [ \frac{{a}_{H}}{4} ] ( {m}_{l} = 3 ) + H ( n = 1 ; {m}_{l} = 0 ) \to H [ \frac{{a}_{H}}{4} ] ( {m}_{l} = - 2 ) + H ( n = 6 ; {m}_{l} = 5 ) + 13.98 eV ( {m}_{l} = 0 ) \qquad ( 42 )$$

The product of the catalysis of atomic hydrogen with potassium metal,

$$H [ \frac{{a}_{H}}{4} ] ,$$

may serve as reactants to form

$$H [ \frac{{a}_{H}}{3} ] and H [ \frac{{a}_{H}}{6} ]$$

according to Eq. (32). The transition of

$$H [ \frac{{a}_{H}}{4} ] to H [ \frac{{a}_{H}}{6} ]$$

induced by a multipole resonance transfer of 54.4 eV, m=2 in Eq. (2) and a transfer of 40.8 eV with a resonance state of

$$H [ \frac{{a}_{H}}{3} ] excited in H [ \frac{{a}_{H}}{4} ] is represented by \\ H [ \frac{{a}_{H}}{4} ] + H [ \frac{{a}_{H}}{4} ] \to H [ \frac{{a}_{H}}{6} ] + H [ \frac{{a}_{H}}{3} ] + 176.8 eV \qquad ( 43 )$$

The predicted 176.8 eV (70.2 Å) photon is a close match with the observed 73.0 Å line of Mills-INP.

The hydrinos are predicted to form hydrino hydride ions. A novel inorganic hydride compound KHI which comprises high binding energy hydride ions was synthesized by reaction of atomic hydrogen with potassium metal and potassium iodide [R. Mills, B. Dhandapani, N. Greenig, J. He, “Synthesis and Characterization of Potassium Iodo Hydride”, Int. J. of Hydrogen Energy, Vol. 25, Issue 12, December, (2000), pp. 1185-1203]. The X-ray photoelectron spectroscopy (XPS) spectrum of KHI differed from that of KI by having additional features at 9.1 eV and 11.1 eV. The XPS peaks centered at 9.0 eV and 11.1 eV that do not correspond to any other primary element peaks may correspond to the H⁻(n=1/4) E_{b}=11.2 eV hydride ion predicted by Mills [Mills GUT] (Eq. (36)) in two different chemical environments where E_{b} is the predicted vacuum binding energy. In this case, the reaction to form H⁻(n=1/4) is given by Eqs. (3-5) and Eq. (38). Hydrino hydride ions H⁻(n=1/4), H⁻(n=1/5), and H⁻(n=1/6) corresponding to the corresponding hydrino atoms were anticipated. The predicted energy of emission due to these ions in the plasma discharge was anticipated to be higher than that given in TABLE 2 due to the formation of stable compounds such as KHI comprising these ions. Emission peaks which could not be assigned to hydrogen, potassium, or iodine were observed at 1032.9 Å (12.0 eV), 677.8 Å (18.3 eV), and 513.6 Å (24.1 eV) [Mills-INP]. The binding energies of hydrino hydride ions H⁻(n=1/4), H⁻(n=1/5), and H⁻(n=1/6) corresponding to the corresponding hydrino atoms are 11.23 eV, 16.7 eV, and 22.81 eV. The emissions were 1 to 2 eV higher than predicted which may be due to the presence of these ions in compounds with chemical environments different from that of vacuum. The excitation was due to the plasma electron bombardment.

### 5.2 Observation of Extreme Ultraviolet Emission from Hydrogen-KI Plasmas Produced by a Hollow Cathode Discharge

### Abstract

A high voltage discharge of hydrogen with and without the presence of a source of potassium, potassium iodide, in the discharge was performed with a hollow cathode. It has been reported that intense extreme ultraviolet (EUV) emission was observed from atomic hydrogen and certain elements or certain ions which ionize at integer multiples of the potential energy of atomic hydrogen, 27.2 eV [1-6]. Two potassium ions or a potassium atom may each provide an electron ionization or transfer reaction that has a net enthalpy equal to an integer multiple of 27.2 eV. The spectral lines of atomic hydrogen were intense enough to be recorded on photographic films only when KI was present. EUV lines not assignable to potassium, iodine, or hydrogen were observed at 73.0, 132.6, 513.6, 677.8, 885.9, and 1032.9 Å. The lines could be assigned to transitions of atomic hydrogen to lower energy levels corresponding to lower energy hydrogen atoms called hydrino atoms and the emission from the excitation of the corresponding hydride ions formed from the hydrino atoms.

### 5.2.1 INTRODUCTION

The chemical interaction of potassium with hydrogen at temperatures below 1000 K has shown surprising results in terms of the emission of the Lyman and Balmer lines [1-6] and the formation of novel chemical compounds [1, 6-12]. In searching for an explanation of chemical reactions of unusually high energy which produced hydrogen Lyman and Balmer series emission, a resonant electronic interaction between hydrogen and potassium at energy levels of a multiple of the ionization energy of hydrogen, nE_{H}, has been introduced into the discussion. This hypothesis is supported by the fact that only those elements such as potassium, cesium, and strontium which have bound electrons of energies of E=nE_{H} show Lyman and Balmer emission during the chemical interaction with atomic hydrogen. Those elements with electronic states of E≠nE_{H} show no emission under identical conditions. This paper addresses new electronic energy states of hydrogen. If such states are stable, spectral line emission should be observed in the EUV during their formation and during energetic electron excitation of compounds containing hydrogen in these states.

The following paper reports the first exploratory measurements in the EUV. For this experiment, a standard hollow cathode discharge in hydrogen was employed to generate atomic hydrogen and to provide the energetic electrons. This papers presents the experimental results and compares it with theoretical considerations.

A historical motivation to cause EUV emission from a hydrogen gas was that the spectrum of hydrogen was first recorded from the only known source, the Sun [13]. Developed sources that provide a suitable intensity are high voltage discharge and inductively coupled plasma generators [14]. An important variant of the later type of source is a tokomak [15]. Fujimoto et al. [16] have determined the cross section for production of excited hydrogen atoms from the emission cross sections for Lyman and Balmer lines when molecular hydrogen is dissociated into excited atoms by electron collisions. This data was used to develop a collisional-radiative model to be used in determining the ratio of molecular-to-atomic hydrogen densities in tokomak plasmas. Their results indicate an excitation threshold of 17 eV for Lyman a emission. Addition of other gases would be expected to decrease the intensity of hydrogen lines which could be absorbed by the gas. Hollander and Wertheimer [17] found that within a selected range of parameters of a plasma created in a microwave resonator cavity, a hydrogen-oxygen plasma displays an emission that resembles the absorption of molecular oxygen. Whereas, a helium-hydrogen plasma emits a very intense hydrogen Lyman α radiation at 121.5 nm which is up to 40 times more intense than other lines in the spectrum. The Lyman α emission intensity showed a significant deviation from that predicted by the model of Fujimoto et al. [16] and from the emission of hydrogen alone.

It has been reported [1-6] that EUV emission of atomic and molecular hydrogen occurs in the gas phase at low temperatures (e.g. <10³ K) upon contact of atomic hydrogen with certain vaporized elements or ions. Atomic hydrogen was generated by dissociation at a tungsten filament and at a transition metal dissociator that was incandescently heated by the filament. Various elements or ions were made gaseous by heating to form a low vapor pressure (e.g. 1 torr). The kinetic energy of the thermal electrons at the experimental temperature of <10³ K were about 0.1 eV, and the average collisional energies of electrons accelerated by the field of the filament were less than 1 eV. (No blackbody emission was recorded for wavelengths shorter than 400 nm.) Atoms or ions which ionize at integer multiples of the potential energy of atomic hydrogen (e.g. cesium, potassium, strontium, and Rb⁺) caused hydrogen EUV emission; whereas, other chemically equivalent or similar atoms (e.g. sodium, magnesium, holmium, and zinc metals) caused no emission. Helium ions present in the experiment of Hollander and Wertheimer [17] ionize at a multiple of two times the potential energy of atomic hydrogen. The mechanism of EUV emission can not be explained by the conventional chemistry of hydrogen, but it is predicted by a solution of the Schrodinger equation with a nonradiative boundary constraint put forward by Mills. [18].

Mills predicts that certain atoms or ions serve as catalysts to release energy from hydrogen to produce an increased binding energy hydrogen atom called a hydrino atom having a binding energy of

$$\begin{matrix}Binding Energy = \frac{13.6 eV}{{n}^{2}} \\ where & ( 1 ) \\ n = \frac{1}{2} , \frac{1}{3} , \frac{1}{4} , … , \frac{1}{p} & ( 2 )\end{matrix}$$

and p is an integer greater than 1, designated as

$$H [ \frac{{a}_{H}}{p} ]$$

where a_{H} is the radius of the hydrogen atom. Hydrinos are predicted to form by reacting an ordinary hydrogen atom with a catalyst having a net enthalpy of reaction of about

m·27.2 eV (3)

where m is an integer. This catalysis releases energy from the hydrogen atom with a commensurate decrease in size of the hydrogen atom, rₙ=na_{H}. For example, the catalysis of H(n=1) to H(n=1/2) releases 40.8 eV, and the hydrogen radius decreases from a_{H} to

$$\frac{1}{2} {a}_{H} .$$

The excited energy states of atomic hydrogen are also given by Eq. (1) except that

n=1,2,3, (4)

The n=1 state is the “ground” state for “pure” photon transitions (the n=1 state can absorb a photon and go to an excited electronic state, but it cannot release a photon and go to a lower-energy electronic state). However, an electron transition from the ground state to a lower-energy state is possible by a nonradiative energy transfer such as multipole coupling or a resonant collision mechanism. These lower-energy states have fractional quantum numbers,

$$n = \frac{1}{integer} .$$

Processes that occur without photons and that require collisions are common. For example, the exothermic chemical reaction of H+H to form H₂ does not occur with the emission of a photon. Rather, the reaction requires a collision with a third body, M, to remove the bond energy−H+H+M→H₂+M* [19]. The third body distributes the energy from the exothermic reaction, and the end result is the H₂ molecule and an increase in the temperature of the system. Some commercial phosphors are based on nonradiative energy transfer involving multipole coupling. For example, the strong absorption strength of Sb³⁺ ions along with the efficient nonradiative transfer of excitation from Sb³⁺ to Mn²⁺, are responsible for the strong manganese luminescence from phosphors containing these ions [20]. Similarly, the n=1 state of hydrogen and the

$$n = \frac{1}{integer}$$

states of hydrogen are nonradiative, but a transition between two nonradiative states is possible via a nonradiative energy transfer, say n=1 to n=1/2. In these cases, during the transition the electron couples to another electron transition, electron transfer reaction, or inelastic scattering reaction which can absorb the exact amount of energy that must be removed from the hydrogen atom. Thus, a catalyst provides a net positive enthalpy of reaction of m·27.2 eV (i.e. it absorbs m·27.2 eV where m is an integer). Certain atoms or ions serve as catalysts which resonantly accept energy from hydrogen atoms and release the energy to the surroundings to effect electronic transitions to fractional quantum energy levels given by Eqs. (1-2).

### 5.2.1.1 Inorganic Catalysts

A catalytic system is provided by the ionization of t electrons from an atom to a continuum energy level such that the sum of the ionization energies of the t electrons is approximately m×27.2 eV where m is an integer. One such catalytic system involves potassium. The first, second, and third ionization energies of potassium are 4.34066 eV, 31.63 eV, 45.806 eV, respectively [21]. The triple ionization (t=3) reaction of K to K³⁺, then, has a net enthalpy of reaction of 81.7426 eV, which is equivalent to m=3 in Eq. (3).

$$\begin{matrix}81.7426 eV + K ( m ) + H [ \frac{{a}_{H}}{p} ] \to {K}^{3 +} + 3 {e}^{-} + H [ \frac{{a}_{H}}{( p + 3 )} ] + [ {( p + 3 )}^{2} - {p}^{2} ] X 13.6 eV & ( 5 ) \\ {K}^{3 +} + 3 {e}^{-} \to K ( m ) + 81.7426 eV & ( 6 )\end{matrix}$$

And, the overall reaction is

$$H [ \frac{{a}_{H}}{p} ] \to H [ \frac{{a}_{H}}{( p + 3 )} ] + [ {( p + 3 )}^{2} - {p}^{2} ] X 13.6 eV \qquad ( 7 )$$

Potassium ions can also provide a net enthalpy of a multiple of that of the potential energy of the hydrogen atom. The second ionization energy of potassium is 31.63 eV; and K⁺ releases 4.34 eV when it is reduced to K. The combination of reactions K⁺ to K²⁺ and K⁺ to K, then, has a net enthalpy of reaction of 27.28 eV, which is equivalent to m=1 in Eq. (3).

$$\begin{matrix}27.28 eV + {K}^{+} + {K}^{+} + H [ \frac{{a}_{H}}{p} ] \to K + {K}^{2 +} + H [ \frac{{a}_{H}}{( p + 1 )} ] + [ {( p + 1 )}^{2} - {p}^{2} ] X 13.6 eV & ( 8 ) \\ K + {K}^{2 +} \to {K}^{+} + {K}^{+} + 27.28 eV & ( 9 )\end{matrix}$$

The overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 10 )$$

### 5.2.1.2 Hydrino Catalysts

Lower-energy hydrogen atoms, “hydrinos”, can act as catalysts because each of the metastable excitation, resonance excitation, and ionization energy of a hydrino atom is m×27.2 eV (Eq. (3)). The transition reaction mechanism of a first hydrino atom affected by a second hydrino atom involves the resonant coupling between the atoms of m degenerate multipoles each having 27.21 eV of potential energy [18]. The energy transfer of m×27.2 eV from the first hydrino atom to the second hydrino atom causes the central field of the first atom to increase by m and its electron to drop m levels lower from a radius of

$$\frac{{a}_{H}}{p}$$

to a radius of

$$\frac{{a}_{H}}{p + m} .$$

The second interacting lower-energy hydrogen is either excited to a metastable state, excited to a resonance state, or ionized by the resonant energy transfer. The resonant transfer may occur in multiple stages. For example, a nonradiative transfer by multipole coupling may occur wherein the central field of the first increases by m, then the electron of the first drops m levels lower from a radius of

$$\frac{{a}_{H}}{p}$$

to a radius of

$$\frac{{a}_{H}}{p + m}$$

with further resonant energy transfer. The energy transferred by multipole coupling may occur by a mechanism that is analogous to photon absorption involving an excitation to a virtual level. Or, the energy transferred by multipole coupling and during the electron transition of the first hydrino atom may occur by a mechanism that is analogous to two photon absorption involving a first excitation to a virtual level and a second excitation to a resonant or continuum level [22-24]. The transition energy greater than the energy transferred to the second hydrino atom may appear as a photon in a vacuum medium.

For example, the transition of

$$H [ \frac{{a}_{H}}{p} ] to H [ \frac{{a}_{H}}{p + m} ]$$

induced by a resonance transfer of m·27.21 eV (Eq. (3)) with a metastable state excited in

$$H [ \frac{{a}_{H}}{{p}^{′}} ]$$

is represented by

$$\begin{matrix}m \cdot 27.2 eV + H [ \frac{{a}_{H}}{{p}^{′}} ] + H [ \frac{{a}_{H}}{p} ] -> {H}^{*} [ \frac{{a}_{H}}{{p}^{′}} ] + H [ \frac{{a}_{H}}{p + m} ] + [ {( p + m )}^{2} - {p}^{2} ] \times 13.6 eV & ( 11 ) \\ {H}^{*} [ \frac{{a}_{H}}{{p}^{′}} ] -> H [ \frac{{a}_{H}}{{p}^{′}} ] + m \cdot 27.2 eV & ( 12 )\end{matrix}$$

And, the overall reaction is

$$H [ \frac{{a}_{H}}{{p}^{′}} ] -> H [ \frac{{a}_{H}}{p + m} ] + [ {( p + m )}^{2} - {p}^{2} ] \times 13.6 eV \qquad ( 13 )$$

where p, p′, and m are integers and the asterisk represents an excited metastable state.

The transition of

$$H [ \frac{{a}_{H}}{p} ] to H [ \frac{{a}_{H}}{p + m} ]$$

induced by a multipole resonance transfer of m·27.21 eV (Eq. (3)) and a transfer of [(p′)²−(p′−m′)²]×13.6 eV−m·27.2 eV with a resonance state of

$$H [ \frac{{a}_{H}}{{p}^{′} - {m}^{′}} ]$$

excited in

$$H [ \frac{{a}_{H}}{{p}^{′}} ]$$

is represented by

$$H [ \frac{{a}_{H}}{{p}^{′}} ] + H [ \frac{{a}_{H}}{p} ] -> H [ \frac{{a}_{H}}{{p}^{′} - {m}^{′}} ] + H [ \frac{{a}_{H}}{p + m} ] + [ ( {( p + m )}^{2} - {p}^{2} ) - ( {p}^{′2} - {( {p}^{′} - {m}^{′} )}^{2} ) ] \times 13.6 eV \qquad ( 14 )$$

where p, p′, m, and m′ are integers.

### 5.2.1.3 Hydride Ions

A novel hydride ion having extraordinary chemical properties given by Mills [18] is predicted to form by the reaction of an electron with a hydrino (Eq. (15)). The resulting hydride ion is referred to as a hydrino hydride ion, designated as H⁻(1/p).

$$H [ \frac{{a}_{H}}{p} ] + {e}^{-} -> {H}^{-} ( 1 / p ) \qquad ( 15 )$$

The hydrino hydride ion is distinguished from an ordinary hydride ion having a binding energy of 0.8 eV. The latter is hereafter referred to as “ordinary hydride ion”. The hydrino hydride ion is predicted [18] to comprise a hydrogen nucleus and two indistinguishable electrons at a binding energy according to the following formula:

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} ) \qquad ( 16 )$$

where p is an integer greater than one, s=1/2, π is pi, is Planck's constant bar, μₒ is the permeability of vacuum, mₑ is the mass of the electron, μₑ is the reduced electron mass, aₒ is the Bohr radius, and e is the elementary charge. The ionic radius is

$${r}_{1} = \frac{{a}_{0}}{p} ( 1 + \sqrt{s ( s + 1 )} ) ; s = \frac{1}{2} \qquad ( 17 )$$

From Eq. (17), the radius of the hydrino hydride ion H⁻(1/p); p=integer is

$$\frac{1}{p}$$

times that of ordinary hydride ion, H⁻(1/1). The predicted binding energies and ionic radii for the first five hydrino hydride ions are given in Table 1.

TABLE 1
The ionization energy of the hydrino hydride ion H⁻(n = 1/p)
as a function of p.

| | | Calculated | Calculated |
|---|---|---|---|
| | r₁ | Ionization | Wavelength |
| Hydride Ion | (aₒ)^{a} | Energy^{b} (eV) | (Å) |
| H⁻(n = 1/2) | 0.9330 | 3.047 | 4070 |
| H⁻(n = 1/3) | 0.6220 | 6.610 | 1880 |
| H⁻(n = 1/4) | 0.4665 | 11.23 | 1100 |
| H⁻(n = 1/5) | 0.3732 | 16.70 | 742 |
| H⁻(n = 1/6) | 0.3110 | 22.81 | 544 |

^{a}from Equation (17)
^{b}from Equation (16)

INP Greifswald, Germany recorded spectra of a hollow cathode plasma source in the range of 2.5 nm to 80 nm at the request of BlackLight Power, Inc. of Cranbury, N.J., USA [25]. This plasma source, called a BLP-source, consisted of a five way cross containing a hollow cathode discharge tube and a heated pipe comprising a reservoir for vaporizing KI. One end of the reservoir was closed, and the other open end was mounted close to the exit of the hollow cathode. The axis of both cylindrical pieces, the hollow cathode and the heated reservoir, were arranged almost perpendicular to each other.

A 4° grazing incidence spectrometer was attached to the BLP-source. At this shallow angle of incidence, a strong astigmatism stretches each point like a divergent light source at the entrance slit into a line in the focal plane. The spectrometer was filled with hydrogen during operation via the BLP source. Due to differential pumping a pressure drop was established between the source and the spectrometer.

The proper functioning of the spectrometer in the desired wavelengths range was demonstrated by using a known capillary discharge in high vacuum that emitted carbon and oxygen spectra of multiply ionized atoms down to 3.5 nm.

Potassium iodide was used as a source of potassium. Based on its reported exceptional emission [1-4, 6], potassium was a good choice for a catalyst according to Eqs. (5-7) to cause transitions in hydrogen to lower energy levels to form hydrino atoms. The hydrino atoms then also served as catalysts according to Eqs (11-13) and Eq. (14). Hydrino hydride ions formed by the reaction of plasma electrons with hydrino atoms. Compounds containing hydrino hydride ions were observed by their characteristic emission when excited in the plasma discharge.

### 5.2.2 METHODS

### Standard Hydrogen Emission Spectrum

A standard atomic and molecular hydrogen extreme ultraviolet emission spectrum was obtained by BlackLight Power, Inc., Cranbury, N.J. with a microwave discharge system and an EUV spectrometer. The microwave generator was a Opthos model MPG-4M generator (Frequency: 2450 MHz). The output power was set at 85 watts. Hydrogen gas was flowed through a half inch diameter quartz tube at 550 mtorr. The tube was fitted with an Opthos coaxial microwave cavity (Evenson cavity). The EUV spectrometer was a McPherson model 302 (Seya-Namioka type) normal incidence monochromator. The monochromator slits was 30×30 μm. A sodium salicylate converter was used, and the emission was detected with a photomultiplier tube detector (Hamamatsu R1527P).

### 5.2.2.1 Capillary Discharge

A certain discharge type has become very important for a couple of special applications. For example, in the field of radiation generation in the EUV or soft x-ray region the so called capillary discharge is often used [26]. Several scientists have shown that it is possible to generate laser radiation at shorter wavelengths by means of a capillary discharge because fast capillary discharges with a large length-to-diameter ratio can generate highly ionized plasmas. The field is quite advanced [27-28] to the point that Rocca [27] has developed a table top laser using the 46.9 nm Argon line.

A high electric power is required to excite atoms to high electronic energy levels. Since a high energy input into a device is unwanted, a technically convenient energy has to be delivered to a plasma in a short time. The capillary discharge described by Bogen, Conrads, Gatti, and Kohlhaas [26] has an electric current rise time and an emission time of the hydrogen like carbon VII line that is shorter than 50 ns.

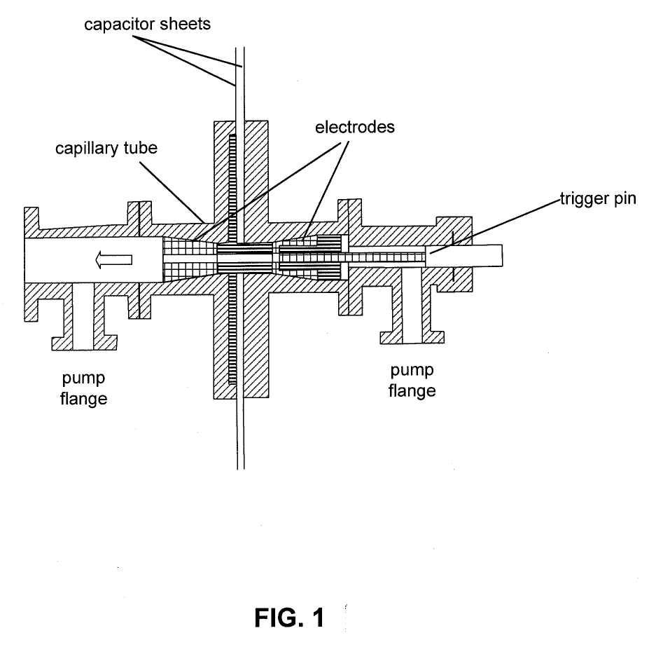

A cross sectional view of the capillary discharge system is shown in FIG. 1. The capacitor, leads, capillary for plasma production, switch, and trigger were all integrated in a single unit in order to maintain a low inductance. The capacitor was a copper laminated plastic sheet with isolation gaps along the rim and in the center. A plastic disc with a plastic cylinder in the center provided additional high voltage insulation. The plastic cylinder penetrated the capacitor and was encapsulated on each end by brass pieces. Hollow carbon electrodes were attached at each end of the plastic cylinder by the brass pieces which pressed the electrodes. The brass pieces were soldered to the copper laminate of the capacitor. The plastic cylinder and the carbon electrodes had a common borehole along the axis of the cylinder.

The plasma was observed end on from one side. On the other side, a carbon trigger pin provided a spark when a sharply rising potential was applied between this trigger pin and one of the carbon electrodes. This spark triggered the discharge of the capacitor. A plasma was formed inside the plastic cylinder borehole which comprised the capillary. This plasma had an electron temperature of up to 50 eV, and an electron density of up to 1025 particles per m³ [29]. The brass pieces were connected to a vacuum system. This arrangement permitted the end-on observation of the generated spark. To avoid a pressure gradient, the trigger side of the discharge as well as the spectrograph side were evacuated by a pumping system shown in FIG. 1.

### 5.2.2.2 System for EUV Measurement of Discharge

In order to protect the electronic devices from destruction and to avoid disturbances while measuring, the discharge source, the entire power supply, and the pumping system was placed in a grounded Faraday cage. The capacitor was charged via 1MΩ resistor. The discharge was driven by a power supply in a voltage range between 6 kV and 10 kV. In addition, a second power supply was used to provide a very fast high voltage pulse (4 kV with a rise time of 10 ns) to the trigger pin. This pulse provided a controlled ignition of the capillary discharge.

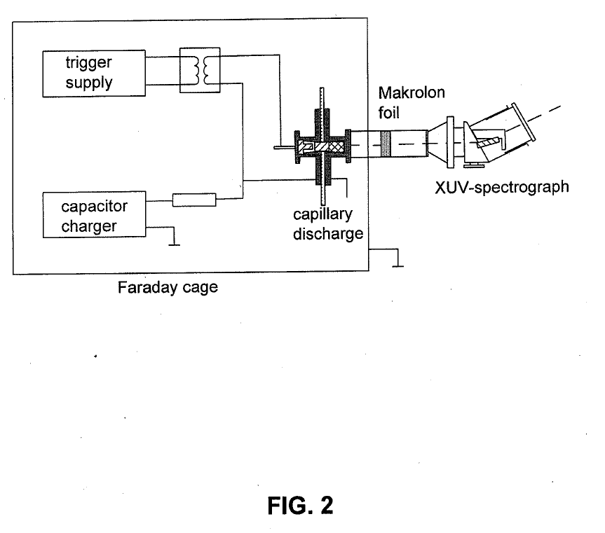

For more convenient operation, the EUV-spectrograph was located outside of the Faraday cage. In a capillary discharge, a spectrum is generated by excitation of atoms of an evaporated dielectric material. Polyethylene (PE) or polyacetal (PA) was used in the present study. The discharge produced a lot of dust. Therefore, a special Makrolon foil (polycarbonate with a thickness of about 200 nm that was transparent to the soft x-ray and EUV region light of this study) was placed between the capillary discharge and the EUV-spectrograph to protect the grating. The spectrograph as well as the whole discharge vessel were connected with a pumping system. The discharge was driven in vacuum at a working pressure of 10⁻⁵ mbar or less. For time resolved measurements, the spectrograph was replaced by a fast photo multiplier that permitted examination of the temporal behavior of a single spark. Table 2 gives the main parameters of this experiment. The experimental setup is shown in FIG. 2.

TABLE 2
Parameters used in the capillary discharge
experiments.

| | |
|---|---|
| discharge voltage V | 6-10 kV |
| discharge pressure p | ≦10⁻⁵ mbar |
| capacitor capacitance C | 19 nF |
| capacitor inductance I | 19 nH |
| thickness of the Makrolon foil b | 200 nm |
| number of single discharges n | about 500 |

### 5.2.2.3 EUV-Spectrograph and Photochemical Detector

The spectrometer was a LSP-VUV 1-3S-M portable EUV grazing incidence spectrometer that used an off Rowland circle registration scheme wherein the diameter of the Rowland circle corresponded to the radius of curvature of the grating. In this study, the spectra were recorded in a single plane. Thus, the input slit was focused only for a single wavelength (center wavelength λ₀). The alignment to a different wavelength was produced by simply changing the distance between the focal plane and the grating. The spectra were detected using a special Russian EUV film.

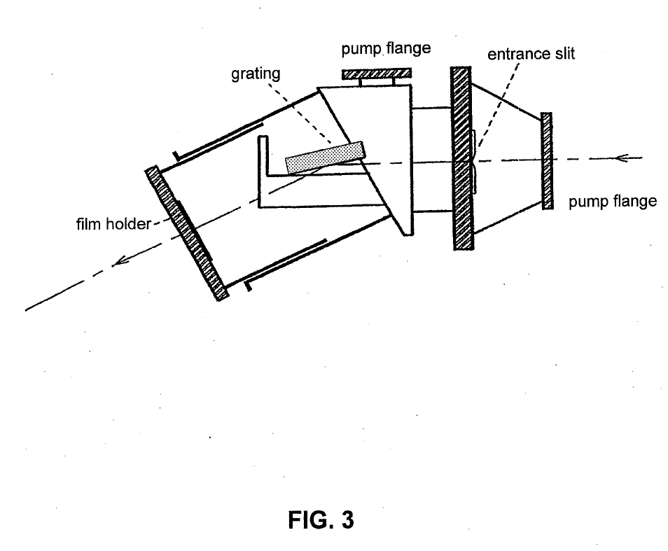

The grazing angle of incidence to the grating was rated by the manufacturer to be 4°. The width of the entrance slit was chosen to be 100 μm. The spectral resolution λ/Δλ was better than 100. The grating parameters are shown in Table 3. The cross sectional view of the EUV-spectrometer is shown in FIG. 3.

TABLE 3
Grating parameters.

| radius of curvature [mm] | 1000 | | |
|---|---|---|---|
| size of ruled area [mm] | 28 × 30 | | |
| coating | Au 300 Å | | |
| number of grooves [/mm] | 1200 | 600 | 300 |
| blaze angle [°] | 1 | 2 | 3 |
| recomended spectral range [Å] | 25-60 | 60-120 | 120-800 |

### 5.2.2.4 Measurements

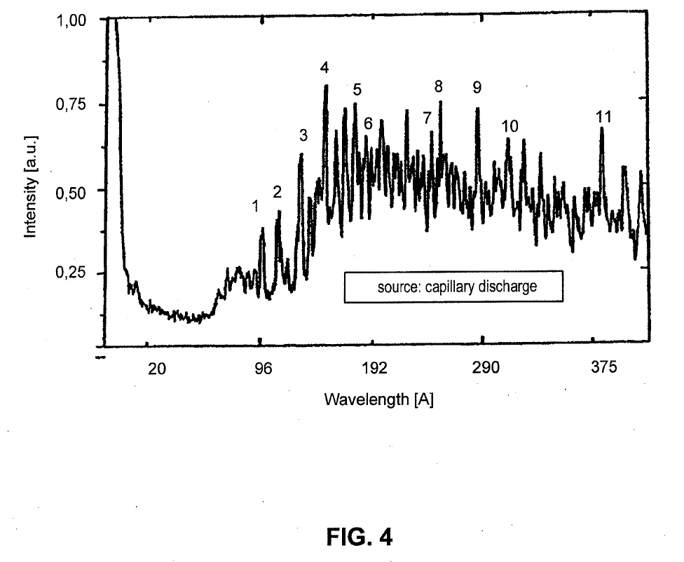

The main purpose for the use of a capillary discharge was to demonstrate the spectral range over which the system was capable of recording. The EUV spectrum of a capillary discharge of a polyacetal capillary tube was obtained with the results given shown in FIG. 4 and in Table 4. The numbered spectral lines (with respect to FIG. 4) are assigned to the corresponding wavelengths and energy levels. For an appropriate assignment, it was necessary to calculate the transformation from the plane of registration to the Rowland circle using the specific dispersion function of the grating. Emission could be observed down to 7 nm.

TABLE 4
Spectral lines of FIG. 4 with corresponding
transitions and wavelengths.

| number | ion | energy level | wavelength [Å] |
|---|---|---|---|
| 1 | O VII | 1s2p-1s4d | 96.1 |
| 2 | O VI | 1s²2p-1s²6d | 110 |
| 3 | O VI | 1s²2p-1s²4d | 130 |
| 4 | O VI | 1s²2s-1s²3p | 150 |
| 5 | O VI | 1s²2p-1s²3d | 173 |
| 6 | O VI | 1s²2p-1s²3s | 184 |
| 7 | C IV | 1s²2p-1s²6d | 245 |
| 8 | C IV | 1s²2p-1s²5d | 259 |
| 9 | C IV | 1s²2p-1s²4d | 289 |
| 10 | C IV | 1s²2s-1s²3p | 312 |
| 11 | C IV | 1s²2p-1s²3d | 384 |

### 5.2.2.5 Experimental Setup of the BLP Source

The emission of the BLP source (BlackLight Power, Inc., Cranbury, N.J.) was investigated in the EUV and soft x-ray region The plasma cell comprised a five-way stainless steel cross. The plasma was generated at a hollow cathode inside the discharge cell. The hollow cathode was constructed of a stainless steel rod inserted into a steel tube, and this assembly was inserted into an Alumina tube. A flange opposite the end of the hollow cathode connected the spectrometer with the cell. It had a small hole that permitted radiation to pass to the spectrometer. In addition, a quartz tube positioned perpendicularly to the hollow cathode was attached to two copper high voltage feedthroughs by means of a tungsten filament. The quartz tube served as a catalyst reservoir when filled with KI.

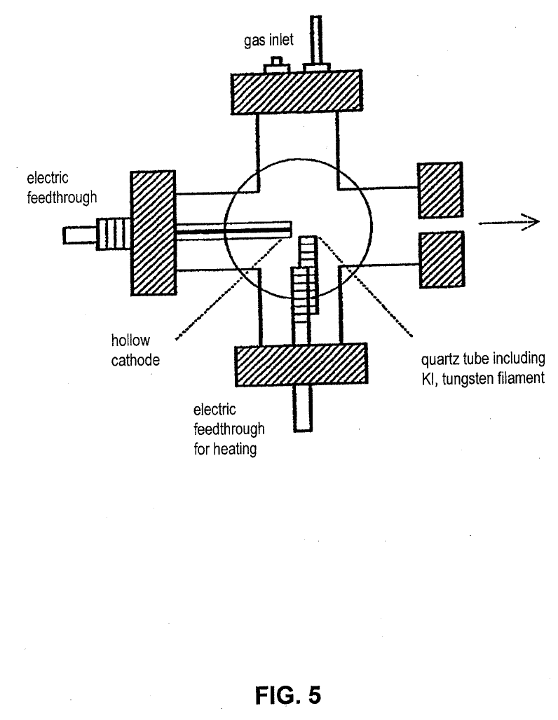

The electrical copper feedthroughs were connected to a power supply (U=0-6.3 V, I=0-40 A) to power the tungsten filament to heat the catalyst in the quartz tube. Some of the KI was observed to vaporize when the filament glowed orange. Another power supply (U=0-20 kV, I=0-30 mA) was connected to the hollow cathode to generate a discharge. A Swagelok adapter at the very end of the steel cross provided a gas inlet and a connection with the pumping system. A diagram of the BLP plasma source is given in FIG. 5.

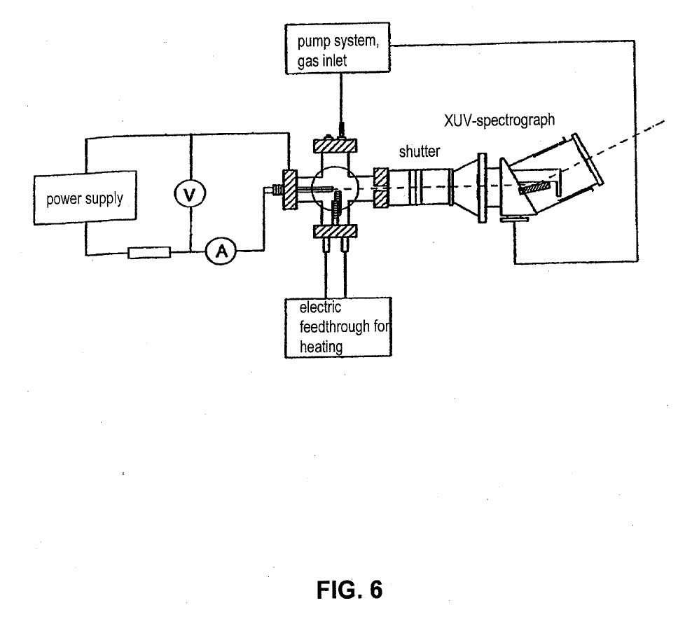

A high speed shutter placed between the discharge cell and the spectrograph allowed for control of the detector exposure time. (See EUV-Spectrograph and Photochemical Detector Section). The hollow cathode, shutter, and EUV spectrograph were aligned on a common optical axis using a laser. The experimental setup for the BLP discharge measurements is illustrated in FIG. 6.

### 5.2.2.6 Measurements on the BLP Source

The temperature of the tungsten filament which heated the quartz tube was determined by means of a special infrared camera system made by Jenoptic. The evaluation photos showed that the filament bad a temperature of at least 1000 K, and the quartz tube was about 80 K colder. The temperature of 920 K was sufficient to melt and vaporize KI in the pressure range of the experiment.

The EUV emission spectrum of the BLP source was obtained during a plasma discharge in hydrogen with and without KI catalyst. Manipulated experimental parameters included the pressure, the temperature and position of the catalyst reservoir, the discharge voltage and current, the time of exposure of the detector film system, the particular grating, and the center wavelength λ₀. The main parameter changes and basic spectrographic findings, are presented.

In order to make the wavelength assignments, all of the films were scanned, and the bitmap files were read out as shown in FIG. 4 for the case of the capillary discharge. The measured and calculated spectral lines were numbered from 1 (inside order) to 23. Corresponding lines of different films were assigned the same number based on the specific distances between the grating and the plane of the film that was a function of λ₀. A first wavelength assignment was performed by calculating the transformation from the plane of registration to the Rowland circle using the specific dispersion function of the particular grating.

A number of experiments proved that line No. 12 was the Lyman alpha line with a known wavelength of 1215.7 Å. This wavelength was used to determine the experimental angle of incidence. Thus, a slight divergence to the experiment was detected (Δ≮=0.33°), and the dispersion function was recalculated using the experimentally determined angle of grazing incidence of α=3.56°.

### 5.2.3 RESULTS

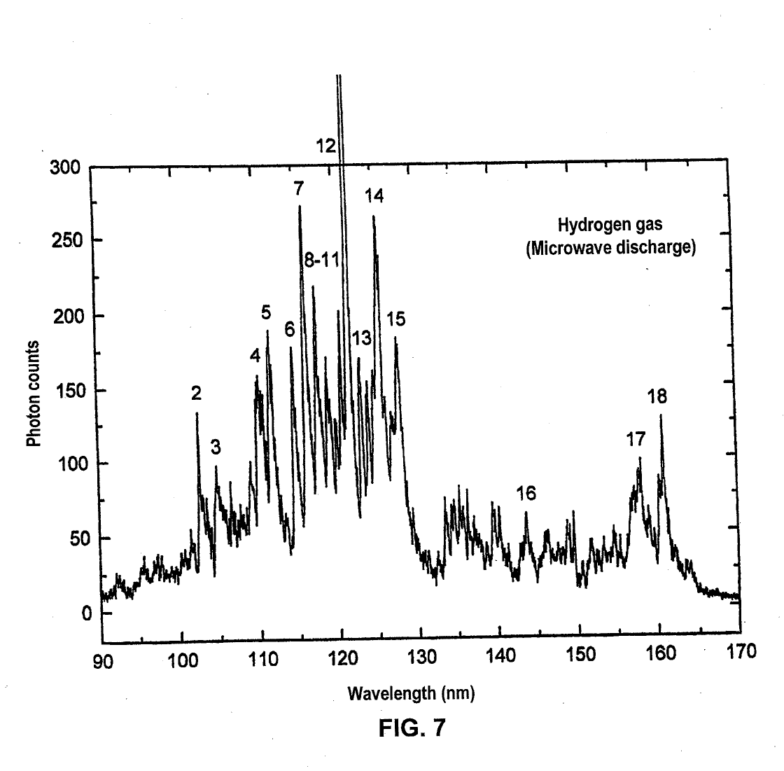

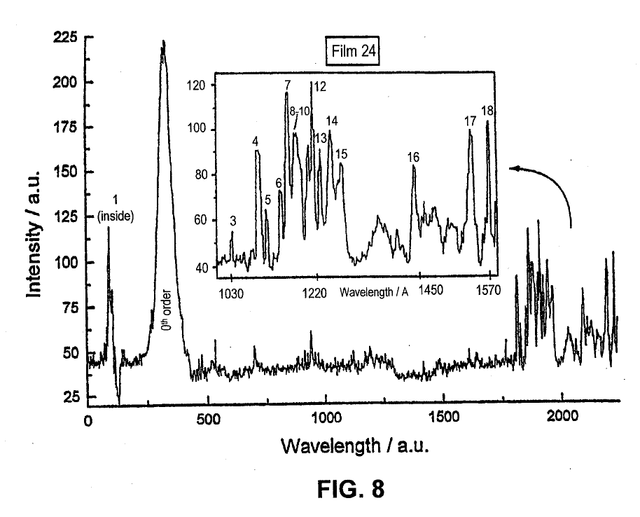

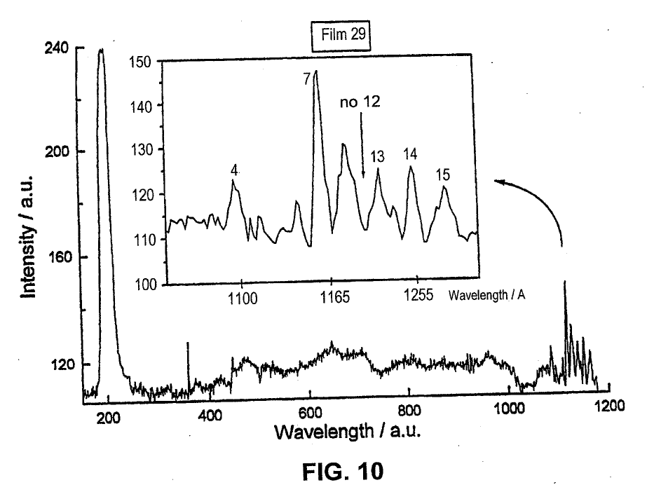

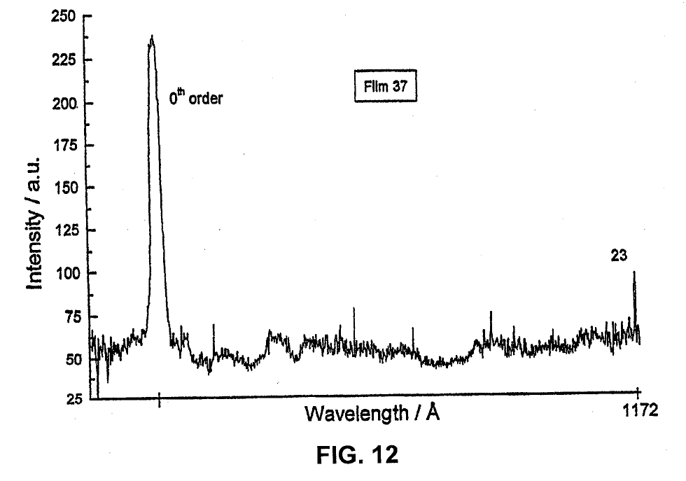

The standard hydrogen emission spectrum (850 and 1750 Å) obtained from a microwave plasma of hydrogen with a standard numbering order used in this analysis is shown in FIG. 7. The standard hydrogen spectrum was recorded by BlackLight Power Inc. using a photomultiplier tube detector. The EUV emission lines from hydrogen-KI plasmas produced by a hollow cathode discharge were recorded and identified on photographic films by INP Greifswald, Germany [25]. In order to make the wavelength assignments, all of the films were scanned, and the bitmap files were read out as shown in FIGS. 8-12. Emission lines versus scratches or other artifacts were determined from the films, and the wavelength assignments were based on the bitmap files shown in FIGS. 8-12. A summary of the wavelength assignments and wavelength assignments based on the corrected calculated dispersion function are given in Table 5. FIGS. 8-12 shows the observed spectral lines that are numbered on the respective numbered films as given in Table 5. Spectra were observed in the range around 100 nm only when KI was present; otherwise, no lines were observed on the films. In addition, the discharge current and a special positioning of the sufficiently heated KI reservoir relative to the powered hollow cathode seem to be essential. The exact positions of the spectral lines were identified by using the Lyman-alpha line of hydrogen as a reference. The spectra comprised narrow and wide lines.

TABLE 5
Wavelength assignments of identified emission peaks.

| | | Angle β/° | | λ/Å | |
|---|---|---|---|---|---|
| | Average distance | measured to 0^{th} | λ/Å | (recalculated | |
| | to 0^{th} order/mm | order | (entrance | entrance angle | |
| Line No. | on film No. # | (grating #3) | angle α = 4° | with α = 3.56°) | Comments |
| 1 (inside) | −5.21/Ø | 1.62 | 80 | 73.0 | |
| 2 | 35.9/#30 | 11.10 | 1070 | 1021.0 | |
| 3 | 36.2/#30 | 11.18 | 1081.9 | 1032.9 | |
| 4 | 37.5/#30 | 11.61 | 1148.5 | 1095.8 | Wide |
| 5 | 37.8/#30 | 11.72 | 1165.5 | 1114.4 | |
| 6 | 38.4/#30 | 11.91 | 1195.7 | 1143.7 | |
| 7 | 38.8/#30 | 12.03 | 1215 | 1162.1 | Wide |
| 8 | 39.1/#30 | 12.12 | 1229.6 | 1176.5 | |
| 9 | 39.2/#30 | 12.15 | 1234.3 | 1181.3 | |
| 10 | 39.3/#30 | 12.18 | 1239 | 1186.0 | |
| 11 | 39.7/#30 | 12.30 | 1258.8 | 1204.8 | |
| 12 | 39.9/#30 | 12.37 | 1270.3 | 1215.7 | Strong, L_{α} |
| 13 | 40.2/#30 | 12.46 | 1284.9 | 1230.8 | |
| 14 | 40.7/#30 | 12.61 | 1309.9 | 1254.7 | |
| 15 | 41.2/#30 | 12.76 | 1335 | 1279.2 | |
| 16 | 44.4/#30 | 13.74 | 1503 | 1443.7 | |
| 17 | 46.26/#24 | 14.30 | 1605.4 | 1541.9 | Wide |
| 18 | 46.78/#24 | 14.46 | 1633.7 | 1570.5 | Wide |
| 19 | 8.57/#28 | 2.66 | 144.1 | 132.6 | Weak |
| 20 | 32.68/#28 | 10.15 | 930.5 | 885.9 | Weak |
| 21 | 22.9/#30 | 7.12 | 544.8 | 513.6 | Weak |
| 22 | 27.5/#30 | 8.55 | 715.5 | 677.8 | Weak |
| 23 | 40.28/#37 | 12.09 | 1224 | 1171.8 | |

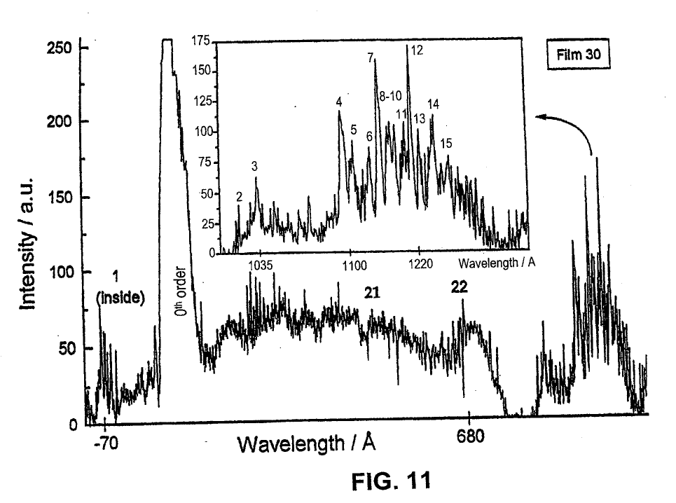

The wavelengths of the standard hydrogen peaks and the experimental peaks numbered 4 to 18 are given in Table 6. These experimental peaks match closely the wavelengths and intensities of the standard atomic and molecular hydrogen peaks. However, the identification of peaks 2 and 3 was problematic. It is known from the standard hydrogen spectrum that the most intense peak in the wavelength region between 102-105 nm is the hydrogen Lyman beta line located at 102.6 nm as shown in FIG. 7. If peak 2 shown in FIG. 11 is the Lyman beta line, then the experimental peak 3 shown FIGS. 8 and 11 are different from the control since the peak 3 is the most intense peak in the region rather than the Lyman beta. Peak 3 could be assigned to H⁻(n=1/4) E_{b}=11.2 eV as given in Table 7.

TABLE 6
Experimental peaks that matched the control hydrogen
spectrum and are assigned to atomic and molecular hydrogen
peaks.

| | Control Hydrogen | Experimental |
|---|---|---|
| Peak Number | (Å) | (Å) |
| 2 | 1025.4 | 1021.0 |
| 3 | 1047.0 | — |
| 4 | 1101.4 | 1095.8 |
| 5 | 1116.2 | 1114.4 |
| 6 | 1144.8 | 1143.7 |
| 7 | 1160.6 | 1162.1 |
| 8 | 1174.9 | 1176.5 |
| 9 | 1188.4 | 1181.3 |
| 10 | 1198.6 | 1186.0 |
| 11 | 1205.8 | 1204.8 |
| 12 | 1215.7 | 1215.7 |
| 13 | 1229.6 | 1230.8 |
| 14 | 1253.4 | 1254.7 |
| 15 | 1277.8 | 1279.2 |
| 16 | 1436.2 | 1443.7 |
| 17 | 1577.9 | 1541.9 |
| 18 | 1607.9 | 1570.5 |
| 23 | same as peak 8 | 1171.8 |

EUV lines not assignable to potassium, iodine, or hydrogen were observed at 73.0, 132.6, 513.6, 677.8, 885.9, and 1032.9 Å. The lines could be assigned to transitions of hydrino atoms and the emission from the excitation of the corresponding hydrino hydride ions. The assignments are given in Table 7.

TABLE 7
Observed emission data from hydrogen-KI plasmas produced by
a hollow cathode discharge that can not be assigned to
atomic or molecular hydrogen.

| | | Observed | Ob- | | Pre- | Prediected |
|---|---|---|---|---|---|---|
| | INP | Wave- | served | | dicted | Wave- |
| | Peak | length | Energy | Peak | Energy | length |
| Peak | # | (Å) | (eV) | Assignment | (eV) | (Å) |
| 1 | #24, | 73.0 | 169.9 | 1/4 → 1/6 H | 176.8 | 70.2 |
| (in- | #30 | | | transition^{a} | | |
| side) | | | | | | |
| 3 | #30 | 1032.9 | 12.0 | H ⁻(1/4)^{b, c} | 11.23 | 1104 |
| 19 | #28 | 132.6 | 93.5 | 1/4 → 1/5 H | 95.2 | 130.3 |
| | | | | transition^{d} | | |
| 20 | #28 | 885.9 | 14.0 | $\begin{matrix}Inelastic H \\ scattering of \\ H * {[ \frac{{a}_{H}}{4} ]}^{e}\end{matrix}$ | 13.98 | 887.2 |
| 21 | #30 | 513.6 | 25.15 | H ⁻(1/6)^{c} | 22.8 | 543 |
| 22 | #30 | 677.8 | 18.30 | H ⁻(1/5)^{c} | 16.7 | 742 |

^{a}Transition induced by a resonance state excited in
$\begin{matrix}H [ \frac{{a}_{H}}{4} ] \\ H [ \frac{{a}_{H}}{4} ] + H [ \frac{{a}_{H}}{4} ] \to H [ \frac{{a}_{H}}{6} ] + H [ \frac{{a}_{H}}{3} ] + 176.8 eV\end{matrix}$
^{b}I⁺has a peak at 1034.66 Å, [31] but none of the other iodine lines were
detected including much stronger lines.
^{c}The hydride ion emission is anticipated to be shift to shorter wavelengths
due to its presence in a chemical compound.
^{d}Transition induced by a metastable state excited in
$\begin{matrix}H [ \frac{{a}_{H}}{4} ] \\ 27.2 eV + H [ \frac{{a}_{H}}{4} ] + H [ \frac{{a}_{H}}{4} ] \to H * [ \frac{{a}_{H}}{4} ] + H * [ \frac{{a}_{H}}{5} ] + 27.2 eV + 95.2 eV \\ H * [ \frac{{a}_{H}}{4} ] \to H [ \frac{{a}_{H}}{4} ] + 27.2 eV \\ H [ \frac{{a}_{H}}{4} ] \to H [ \frac{{a}_{H}}{5} ] + 95.2 eV + 27.2 eV\end{matrix}$
${}^{e} Hydrogen inelastic scattered peak of H * [ \frac{{a}_{H}}{4} ] deexcitation$
$H * [ \frac{{a}_{H}}{4} ] + H ( n = 1 ; {m}_{l} = 0 ) \to H [ \frac{{a}_{H}}{4} ] + H ( n = 6 ; {m}_{l} = 5 ) + 13.98 eV$

The line at 73 Å which appeared as an inside-order-line was reproducible and was probably real. But, it had to be questioned, because of the observation of bunching into the sagittal direction and interference patterns into the meridional direction. This line was produced by the grating and was not subject to reflections as were some “ghosts” appearing as “absorption-lines” independently of the grating rulings. This “inside-order-line” vanished, when gratings with double or quadruple rulings were used. It can not be excluded, that stimulated emission at this wavelength occurred from the hydrogen-KI-plasma inside the hollow cathode or the area in front of it. According to the characteristics of the grating, the true wavelength could also be one half, one third, or less likely one forth of 73 Å. It must be regarded as belonging to the regular emission of EUV light of the BLP plasma source.

By measuring the distances between the spectral lines on the printed scans and comparing it to those on the films, the average error in the calculation of the assigned wavelengths was determined to be about 30 Å in the region above 800 Å. Line 12 was determined to be the Lyman alpha line of hydrogen (λ=1215.7 Å) by comparing the structure of lines 3 to 15 with the known spectrum of hydrogen. This line was used to recalculate the dispersion function of grating #3. The error in the corrected data was about ±3 Å.

### 5.2.4 DISCUSSION

The results support that potassium atoms reacted with atomic hydrogen to form novel hydrogen energy states. Potassium iodide present in the discharge of hydrogen served as a source of potassium metal which was observed to collect on the walls of the cell during operation. According to Eqs. (5-7), potassium metal reacts with atomic hydrogen present in the discharge and forms the hydrino atom

$$H [ \frac{{a}_{H}}{4} ] .$$

The energy released was expected to undergo internal conversion to increase the brightness of the plasma discharge since this is the common mechanism of relaxation. This is consistent with observation.

The product,

$$H [ \frac{{a}_{H}}{4} ]$$

may serve as a catalyst to form

$$H [ \frac{{a}_{H}}{5} ]$$

according to Eqs. (11-13). The transition of

$$H [ \frac{{a}_{H}}{4} ] to H [ \frac{{a}_{H}}{5} ]$$

induced by a resonance transfer of 27.21 eV, m=1 in Eq. (3) with a metastable state excited in

$$H [ \frac{{a}_{H}}{4} ]$$

is represented by

$$\begin{matrix}27.2 eV + H [ \frac{{a}_{H}}{4} ] + H [ \frac{{a}_{H}}{4} ] \to {H}^{*} [ \frac{{a}_{H}}{4} ] + H [ \frac{{a}_{H}}{5} ] + 27.2 eV + 95.2 eV & ( 18 ) \\ {H}^{*} [ \frac{{a}_{H}}{4} ] \to H [ \frac{{a}_{H}}{4} ] + 27.2 eV & ( 19 ) \\ H [ \frac{{a}_{H}}{4} ] \to H [ \frac{{a}_{H}}{5} ] + 95.2 eV + 27.2 eV & ( 20 )\end{matrix}$$

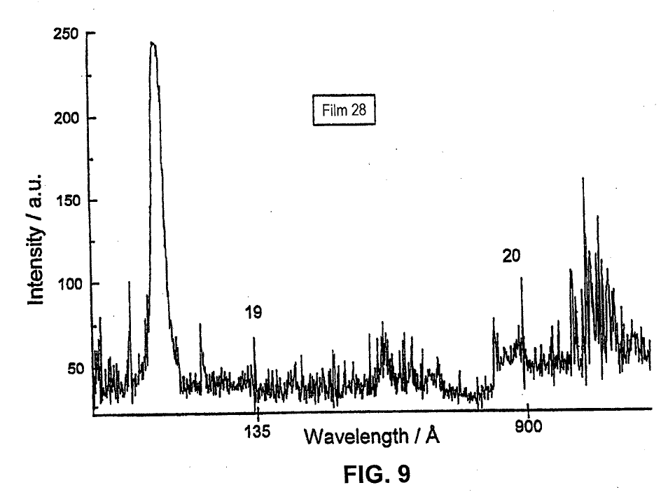

The energy emitted by a hydrino which has nonradiatively transferred m×27.2 eV of energy to a second hydrino may be emitted as a spectral line. Hydrinos may only accept energy by a nonradiative mechanism [18]; thus, rather than suppressing the emission through internal conversion they do not interact with the emitted radiation. The predicted 95.2 eV (130.3 Å) photon (peak #19) shown in FIG. 9 is a close match with the observed 132.6 Å line. In FIG. 9, an additional peak (peak #20) was observed at 885.9 Å. It is proposed that peak #20 arises from inelastic hydrogen scattering of the metastable state

$${H}^{*} [ \frac{{a}_{H}}{4} ]$$

formed by the resonant nonradiative energy transfer of 27.2 eV from a first

$$H [ \frac{{a}_{H}}{4} ]$$

atom to a second as shown in Eq. (18). The metastable state then nonradiatively transfers part of the 27.2 eV excitation energy to excite atomic hydrogen initially in the state 1s ²S_{1/2} to the state 6h ²H_{11/2}. This leaves a 13.98 eV (887.2 Å) photon, peak 20. The initial and final states for all hydrogen species and emitted photons are determined by the selection rule for conservation of angular momentum where the 13.98 eV photon corresponds to mₗ=0 and the initial and final states for the hydrino atom catalysts correspond to mₗ=3 and mₗ=−2, respectively. In the case that the 95.2 eV (130.3 Å) photon (peak #19) corresponds to mₗ=0 or ±1, then angular momentum is conserved. The excited state hydrogen may then emit hydrogen lines that are observed in FIG. 9. Thus, the inelastic hydrogen scattering of the deexcitation of

$${H}^{*} [ \frac{{a}_{H}}{4} ]$$

may be represented by

$${H}^{*} [ \frac{{a}_{H}}{4} ] ( {m}_{l} = 3 ) + H ( n = 1 ; {m}_{l} = 0 ) \to H [ \frac{{a}_{H}}{4} ] ( {m}_{l} = - 2 ) + H ( n = 6 ; {m}_{l} = 5 ) + 13.98 eV ( {m}_{l} = 0 ) \qquad ( 21 )$$

The product of the catalysis of atomic hydrogen with potassium metal,

$$H [ \frac{{a}_{H}}{4} ]$$

may serve as both a catalyst and a reactant to form

$$H [ \frac{{a}_{H}}{3} ] and H [ \frac{{a}_{H}}{6} ]$$

according to Eq. (14). The transition of

$$H [ \frac{{a}_{H}}{4} ] to H [ \frac{{a}_{H}}{6} ]$$

induced by a multipole resonance transfer of 54.4 eV, m=2 in Eq. (3) and a transfer of 40.8 eV with a resonance state of

$$H [ \frac{{a}_{H}}{3} ]$$

excited in

$$H [ \frac{{a}_{H}}{4} ]$$

is represent by

$$H [ \frac{{a}_{H}}{4} ] + H [ \frac{{a}_{H}}{4} ] \to H [ \frac{{a}_{H}}{6} ] + H [ \frac{{a}_{H}}{3} ] + 176.8 eV \qquad ( 22 )$$

The predicted 176.8 eV (70.2 Å) photon is a close match with the observed 73.0 Å line.

The hydrinos are predicted to form hydrino hydride ions.

A novel inorganic hydride compound KHI which comprises high binding energy hydride ions was synthesized by reaction of atomic hydrogen with potassium metal and potassium iodide [7]. The X-ray photoelectron spectroscopy (XPS) spectrum of KHI differed from that of KI by having additional features at 9.1 eV and 11.1 eV. The XPS peaks centered at 9.0 eV and 11.1 eV that do not correspond to any other primary element peaks may correspond to the H⁻(n=1/4) E_{b}=11.2 eV hydride ion predicted by Mills [18] (Eq. (16)) in two different chemical environments where E_{b} is the predicted vacuum binding energy. In this case, the reaction to form H⁻(n=1/4) is given by Eqs. (5-7) and Eq. (15). Hydrino hydride ions H⁻(n=1/4), H⁻(n=1/5), and H⁻(n=1/6) corresponding to the corresponding hydrino atoms were anticipated. The predicted energy of emission due to these ions in the plasma discharge was anticipated to be higher than that given in Table 1 due to the formation of stable compounds such as KHI comprising these ions. Emission peaks which could not be assigned to hydrogen, potassium, or iodine were observed at 1032.9 Å (12.0 eV), 677.8 Å (18.3 eV), and 513.6 Å (24.1 eV). The binding energies of hydrino hydride ions H⁻(n=1/4), H⁻(n=1/5), and H⁻(n=1/6) corresponding to the corresponding hydrino atoms are 11.23 eV, 16.7 eV, and 22.81 eV. The emissions were 1 to 2 eV higher than predicted which may be due to the presence of these ions in compounds with chemical environments different from that of vacuum. The excitation was due to the plasma electron bombardment. Additional studies are in progress to collect the compounds formed in the reaction chamber so that XPS may be performed and the XPS spectrum may be compared with the EUV peaks.

### 5.2.5 CONCLUSION

Lines which could be assigned to all of the hydrino transitions and hydrino hydride ions possible in the spectral range of 2.5 nm to 180 nm starting with a potassium catalyst (Eqs. (5-7)) were observed. Intense EUV emission was observed from atomic hydrogen in the presence of potassium which ionizes at integer multiples of the potential energy of atomic hydrogen (Eq. (3)). The release of energy from hydrogen as evidenced by the EUV emission must result in a lower-energy state of hydrogen. The data supports that potassium metal reacts with atomic hydrogen present in the discharge and forms the hydrino atom

$$H [ \frac{{a}_{H}}{4} ] .$$

The energy released undergoes internal conversion to increase the brightness of the plasma discharge. The product,

$$H [ \frac{{a}_{H}}{4} ]$$

serves as both a catalyst and a
reactant to form

$$H [ \frac{{a}_{H}}{5} ]$$

with a 132.6 Å and 885.9 Å emission and

$$H [ \frac{{a}_{H}}{6} ]$$

with a 73.0 Å emission according to Eqs. (18-21) and Eq. (22), respectively. Hydrino hydride ions H⁻(n=1/4), H⁻(n=115), and H⁻(n=1/6) corresponding to the hydrino atoms of the same quantum state were formed in the plasma as evidenced by the emissions at 513.6, 677.8, and 1032.9 Å, respectively. The emissions were 1 to 2 eV higher than predicted which may be due to the presence of these ions in compounds with chemical environments different from that of vacuum. Novel compounds containing hydrino hydride ions have been isolated as products of the reaction of atomic hydrogen with potassium atoms and ions [6-12] identified as catalysts in a recent EUV study [1-4]. The formation of novel compounds based on hydrino atoms is substantial evidence supporting catalysis of hydrogen as the mechanism of the observed EUV emission.

J. J. Balmer showed in 1885 that the frequencies for some of the lines observed in the emission spectrum of atomic hydrogen could be expressed with a completely empirical relationship. This approach was later extended by J. R. Rydberg, who showed that all of the spectral lines of atomic hydrogen were given by the equation:

$$\overline{v} = R ( \frac{1}{{n}_{f}^{2}} - \frac{1}{{n}_{i}^{2}} ) \qquad ( 23 )$$

where R=109,677 cm⁻¹, n_{f}=1, 2, 3, . . . , n=2, 3, 4, . . . , and nᵢ>n_{f}.

Niels Bohr, in 1913, developed a theory for atomic hydrogen that gave energy levels in agreement with Rydberg's equation. An identical equation, based on a totally different theory for the hydrogen atom, was developed by E. Schrödinger, and independently by W. Heisenberg, in 1926.

$$\begin{matrix}{E}_{n} = - \frac{{e}^{2}}{{n}^{2} 8 {πɛ}_{o} {a}_{H}} = - \frac{13.598 eV}{{n}^{2}} & ( 24 a ) \\ n = 1 , 2 , 3 , … & ( 24 b )\end{matrix}$$

where a_{H} is the Bohr radius for the hydrogen atom (52.947 pm), e is the magnitude of the charge of the electron, and ∈ₒ is the vacuum permittivity. The EUV emission of atomic hydrogen with a source of potassium indicates that Eq. (24b), should be replaced by Eq. (24c).

$$n = 1 , 2 , 3 , … , and , n = \frac{1}{2} , \frac{1}{3} , \frac{1}{4} , … \qquad ( 24 c )$$

A number of independent experimental observations also lead to the conclusion that atomic hydrogen can exist in fractional quantum states that are at lower energies than the traditional “ground” (n=1) state. The detection of atomic hydrogen in fractional quantum energy levels below the traditional “ground” state—hydrinos—was reported [18, 30] by the assignment of soft x-ray emissions from the interstellar medium, the Sun, and stellar flares, and by assignment of certain lines obtained by the far-infrared absolute spectrometer (FIRAS) on the Cosmic Background Explorer. The assigned hydrogen transition reactions were similar to those shown in Table 7. The detection of a new molecular species—the diatomic hydrino molecule—was reported by the assignment of certain infrared line emissions from the Sun. The detection of a new hydride species-hydrino hydride ion—was reported by the assignment of certain soft X-ray, ultraviolet (UV), and visible emissions from the Sun. This has implications for several unresolved astrophysical problems such as the Solar neutrino paradox and the identity of dark matter. The present study also has the important technological implications of the discovery of a new energy source and a new field of hydrogen chemistry.

### 5.2.6 REFERENCES

1. R. Mills, J. Dong, Y. Lu, “Observation of Extreme Ultraviolet Hydrogen Emission from Incandescently Heated Hydrogen Gas with Certain Catalysts”, 1999 Pacific Conference on Chemistry and Spectroscopy and the 35th ACS Western Regional Meeting, Ontario Convention Center, California, (Oct. 6-8, 1999).
2. R. Mills, J. Dong, Y. Lu, “Observation of Extreme Ultraviolet Hydrogen Emission from Incandescently Heated Hydrogen Gas with Certain Catalysts”, Int. J. Hydrogen Energy, Vol. 25, (2000), pp. 919-943.
3. R. Mills, “Temporal Behavior of Light-Emission in the Visible Spectral Range from a T1-K2CO3-H-Cell”, Int. J. Hydrogen Energy, in press.
4. R. Mills, Y. Lu, and T. Onuma, “Formation of a Hydrogen Plasma from an Incandescently Heated Hydrogen-Potassium Gas Mixture and Plasma Decay Upon Removal of Heater Power”, Int. J. Hydrogen Energy, in press.
5. R. Mills, M. Nansteel, and Y. Lu, “Observation of Extreme Ultraviolet Hydrogen Emission from Incandescently Heated Hydrogen Gas with Strontium that Produced an Anomalous Optically Measured Power Balance”, Int. J. Hydrogen Energy, in press.
6. R. Mills, B. Dhandapani, N. Greenig, J. He, J. Dong, Y. Lu, and H. Conrads, “Formation of an Energetic Plasma and Novel Hydrides from Incandescently Heated Hydrogen Gas with Certain Catalysts”, June ACS Meeting (29th Northeast Regional Meeting, University of Connecticut, Storrs, Conn., (Jun. 18-21, 2000)).
7. R. Mills, B. Dhandapani, N. Greenig, J. He, “Synthesis and Characterization of Potassium Iodo Hydride”, Int. J. of Hydrogen Energy, in press.
8. R. Mills, “Novel Inorganic Hydride”, Int. J. of Hydrogen Energy, Vol. 25, (2000), pp. 669-683.
9. R. Mills, “Novel Hydrogen Compounds from a Potassium Carbonate Electrolytic Cell”, Fusion Technology, Vol. 37, No. 2, March, (2000), pp. 157-182.
10. R. Mills, J. He, and B. Dhandapani, “Novel Hydrogen Compounds”, 1999 Pacific Conference on Chemistry and Spectroscopy and the 35th ACS Western Regional Meeting, Ontario Convention Center, California, (Oct. 6-8, 1999).
11. R. Mills, B. Dhandapani, M. Nansteel, J. He, “Synthesis and Characterization of Novel Hydride Compounds”, Int. J. of Hydrogen Energy, in press.
12. R. Mills, “Highly Stable Novel Inorganic Hydrides”, Journal of Materials Research, submitted.
13. Phillips, J. H., Guide to the Sun, Cambridge University Press, Cambridge, Great Britain, (1992), pp. 16-20.
14. J. A. R. Sampson, Techniques of Vacuum Ultraviolet Spectroscopy, Pied Publications, (1980), pp. 94-179.
15. Science News, Dec. 6, 1997, p. 366.
16. T. Fujimoto, K. Sawada, and K. Takahata, J. Appl. Phys., Vol. 66 (6), (1989), pp. 2315-2319.
17. A. Hollander, and M. R. Wertheimer, J. Vac. Sci. Technol. A, Vol. 12 (3), (1994), pp. 879-882.
18. R. Mills, The Grand Unified Theory of Classical Quantum Mechanics, January 2000 Edition, BlackLight Power, Inc., Cranbury, N.J., Distributed by Amazon.com.
19. N. V. Sidgwick, The Chemical Elements and Their Compounds, Volume I, Oxford, Clarendon Press, (1950), p. 17.
20. M. D. Lamb, Luminescence Spectroscopy, Academic Press, London, (1978), p. 68.
21. David R. Linde, CRC Handbook of Chemistry and Physics, 79 th Edition, CRC Press, Boca Raton, Fla., (1998-9), p. 10-175 to p. 10-177.
22. Thompson, B. J., Handbook of Nonlinear Optics, Marcel Dekker, Inc., New York, (1996), pp. 497-548.
23. Shen, Y. R., The Principles of Nonlinear Optics, John Wiley & Sons, New York, (1984), pp. 203-210.
24. B. de Beauvoir, F. Nez, L. Julien, B. Cagnac, F. Biraben, D. Touahri, L. Hilico, O. Acef, A. Clairon, and J. J. Zondy, Physical Review Letters, Vol. 78, No. 3, (1997), pp. 440-443.
25. J. P. F. Conrads, S. Goetze, J. Schwartz, H. Lange, “Investigation of Hydogen-KI Plasmas Produced by a Hollow Cathode Discharge”, Dec. 18, 1998, Institut fur Niedertemperatur-Plasmaphysik e.V., Friedrich-Ludwig-Jahn-Strasse 19, 17489 Greifswald, Germany.
26. P. Bogen, H. Conrads, G. Gatti, and W. Kohlhaas, JOSA, Vol. 58, No. 3, (1968), pp. 203-206.
27. J. J. Rocca, M. C. Marconi, F. G. Tomasel, J. Quant. Electr., Vol. 29 (1983) 180.
28. H. J. Kunze, K. N. Koshelev, C. Steden, D. Uskov, H. T. Wiesebrink, Phys. Rev. A 193 (1993) 183.
29. J. P. F. Conrads, Institut fur Niedertemperatur-Plasmaphysik e.V., personal communication.
30. R. Mills, “The Hydrogen Atom Revisited”, Int. J. of Hydrogen Energy, in press.
31. NIST Atomic Spectra Database, www.physics.nist.gov/cgi-bin/AtData/display.ksh.

1. A method of producing light, plasma, power, or compounds containing lower energy hydrogen comprising a reaction of lower energy atomic hydrogen whereby a catalyzed lower energy hydrogen atom serves as a reactant of a disproportionation reaction whereby it which accepts energy from an second catalyzed lower energy hydrogen atom to cause a further release of energy as the first atom undergoes a nonradiative electronic transition to a higher nonionized energy level while the second undergoes a transition to a lower energy level.

2. The method of claim 1 whereby lower-energy hydrogen atoms are generated by the catalysis of atomic hydrogen.

3. The method of claim 2 whereby the catalysis of atomic hydrogen comprises the reaction of atomic hydrogen with a catalyst that provides a net enthalpy of reaction of an integer multiple of 27.2 eV to form a hydrogen atom having a binding energy of
$$Binding Energy = \frac{13.6 eV}{{( \frac{1}{p} )}^{2}}$$
where p is an integer greater than 1, preferably from 2 to 200.

4. The method of claim 3 wherein the catalyst is selected from the group of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, He⁺, Na⁺, Rb⁺, Fe³⁺, Mo²⁺, Mo⁴⁺, In³⁺, He⁺, Ar⁺, Xe⁺, Ar²⁺ and H⁺, and Ne⁺ and H⁺ and K⁺ and K⁺.

5. The method of claim 1 further comprising a metastable excitation, resonance excitation, or ionization of a hydrino atom involving a nonradiative energy transfer between lower energy atoms of hydrogen of m×27.2 eV where m is an integer.

6. The method of claim 5 whereby the resonant transfer occurs in multiple stages.

7. The method of claim 1 comprising the transition of
$$H [ \frac{{a}_{H}}{p} ] to H [ \frac{{a}_{H}}{p + m} ]$$
induced by a resonance transfer of m·27.21 eV with a metastable state excited in
$$H [ \frac{{a}_{H}}{{p}^{′}} ]$$
which is represented by
$$m \cdot 27.2 eV + H [ \frac{{a}_{H}}{{p}^{′}} ] + H [ \frac{{a}_{H}}{p} ] \to H * [ \frac{{a}_{H}}{{p}^{′}} ] + H [ \frac{{a}_{H}}{p + m} ] + [ {( p + m )}^{2} - {p}^{2} ] X 13.6 eV$$
$$H * [ \frac{{a}_{H}}{{p}^{′}} ] \to H [ \frac{{a}_{H}}{{p}^{′}} ] + m \cdot 27.2 eV$$
And, the overall reaction is
$$H [ \frac{{a}_{H}}{p} ] \to H [ \frac{{a}_{H}}{p + m} ] + [ {( p + m )}^{2} - {p}^{2} ] X 13.6 eV$$
where p, p′, and m are integers and the asterisk represents an excited metastable state.

8. The method of claim 1 comprising the transition of
$$H [ \frac{{a}_{H}}{p} ] to H [ \frac{{a}_{H}}{p + m } ]$$
induced by a multipole resonance transfer of m·27.21 eV and a transfer of [(p′)²−(p′−m′)²]×13.6 eV−m·27.2 eV with a resonance state of
$$H [ \frac{{a}_{H}}{{p}^{′} - {m}^{′}} ]$$
excited in
$$H [ \frac{{a}_{H}}{{p}^{′}} ]$$
which is represented by
$$H [ \frac{{a}_{H}}{{p}^{′}} ] + H [ \frac{{a}_{H}}{p} ] \to H [ \frac{{a}_{H}}{{p}^{′} - {m}^{′}} ] + H [ \frac{{a}_{H}}{p + m } ] + [ \begin{matrix}( {( p + m )}^{2} - {p}^{2} ) - \\ ( {{p}^{′}}^{2} - {( {p}^{′} - {m}^{′} )}^{2} )\end{matrix} ] X 13.6 eV$$
where p, p′, m, and m′ are integers.

9. The method of claim 5 comprising a disproportionation reaction whereby the transition cascade for the pth cycle of the hydrogen-type atom,
$$H [ \frac{{a}_{H}}{p} ] ,$$
with the hydrogen-type atom,
$$H [ \frac{{a}_{H}}{{m}^{′}} ] ,$$
that is ionized as the source of a net enthalpy of reaction of m×27.2 eV where m is an integer that causes the transition is represented by
$$m X 27.21 eV + H [ \frac{{a}_{H}}{{m}^{′}} ] + H [ \frac{{a}_{H}}{p} ] \to {H}^{+} + {e}^{-} + H [ \frac{{a}_{H}}{( p + m )} ] + [ \begin{matrix}{( p + m )}^{2} - {p}^{2} - \\ ( {{m}^{′}}^{2} - 2 m )\end{matrix} ] X 13.6 eV$$
$${H}^{+} + {e}^{-} \to H [ \frac{{a}_{H}}{1} ] + 13.6 eV$$
And, the overall reaction is
$$H [ \frac{{a}_{H}}{{m}^{′}} ] + H [ \frac{{a}_{H}}{p} ] \to H [ \frac{{a}_{H}}{1} ] + H [ \frac{{a}_{H}}{( p + m )} ] + [ 2 p m + {m}^{2} - {{m}^{′}}^{2} ] X 13.6 eV + 13.6 eV$$

10. The method of claim 1 wherein a lower energy hydrogen compound is produced comprising
(a) at least one neutral, positive, or negative increased binding energy hydrogen species having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions, or is negative; and
(b) at least one other element.

11. A method of claim 10 wherein the lower energy hydrogen compound is produced which is characterized in that the increased binding energy hydrogen species is selected from the group consisting of Hₙ, Hₙ⁻ and Hₙ⁺ where n is a positive integer, with the proviso that n is greater than 1 when H has a positive charge.

12. A method of claim 10 wherein the lower energy hydrogen compound is produced which is characterized in that the increased binding energy hydrogen species is selected from the group consisting of (a) hydride ion having a binding energy that is greater than the binding of ordinary hydride ion (about 0.8 eV) for p=2 up to 23 in which the binding energy is represented
$$by Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} )$$
where p is an integer greater than one, s=1/2, π is pi, is Planck's constant bar, μₒ is the permeability of vacuum, mₑ is the mass of the electron, μₑ is the reduced electron mass, aₒ is the Bohr radius, and e is the elementary charge; (b) hydrogen atom having a binding energy greater than about 13.6 eV; (c) hydrogen molecule having a first binding energy greater than about 15.5 eV; and (d) molecular hydrogen ion having a binding energy greater than about 16.4 eV.

13. A method of claim 12 wherein the lower energy hydrogen compound is produced which is characterized in that the increased binding energy hydrogen species is a hydride ion having a binding energy of about 3.0, 6.6, 11.2, 16.7, 22.8, 29.3, 36.1, 42.8, 49.4, 55.5, 61.0, 65.6, 69.2, 71.5, 72.4, 71.5, 68.8, 64.0, 56.8, 47.1, 34.6, 19.2, or 0.65 eV.

14. A method of claim 10 wherein the lower energy hydrogen compound is produced which is characterized in that the increased binding energy hydrogen species is a hydride ion having the binding energy:
$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} )$$
where p is an integer greater than one, s=1/2, π is pi, is Planck's constant bar, μₒ is the permeability of vacuum, mₑ is the mass of the electron, μₑ is the reduced electron mass, aₒ is the Bohr radius, and e is the elementary charge.

15. A method of claim 10 wherein the lower energy hydrogen compound is produced which is characterized in that the increased binding energy hydrogen species is selected from the group consisting of
(a) a hydrogen atom having a binding energy of about
$$\frac{13.6 eV}{{( \frac{1}{p} )}^{2}}$$
where p is an integer
(b) an increased binding energy hydride ion (H⁻) having a binding energy of about
$$\frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} )$$
pi, is Planck's constant bar, μₒ is the permeability of vacuum, mₑ is the mass of the electron, μₑ is the reduced electron mass, aₒ is the Bohr radius, and e is the elementary charge;
(c) an increased binding energy hydrogen species H₄⁺(1/p);
(d) an increased binding energy hydrogen species trihydrino molecular ion, H₃⁺(1/p), having a binding energy of about
$$\frac{22.6}{{( \frac{1}{p} )}^{2} } eV$$
where p is an integer,
(e) an increased binding energy hydrogen molecule having a binding energy of about
$$\frac{15.5}{{( \frac{1}{p} )}^{2} } eV ;$$
and
(f) an increased binding energy hydrogen molecular ion with a binding energy of about
$$\frac{16.4}{{( \frac{1}{p} )}^{2} } eV .$$
